(19) United States
(12) Patent Application Publication
(10) Pub. No.: US 2014/0065407 A1
(43) Pub. Date: Mar. 6, 2014

(54) MANUFACTURE OF LITHOGRAPHIC PRINTING PLATE PRECURSORS FOR ABLATION IMAGING

(71) Applicants: Moshe Nakash, Ramat Hashron (IL); Daniel Welzman, Ramat Gan (IL)

(72) Inventors: Moshe Nakash, Ramat Hashron (IL); Daniel Welzman, Ramat Gan (IL)

(21) Appl. No.: 13/597,395

(22) Filed: Aug. 29, 2012

(51) Int. Cl. B41L 17/00; B32B 3/26; B29C 59/16

(52) U.S. Cl. 428/315.9; 427/144; 264/447

(57) ABSTRACT

Positive-working lithographic printing plate precursors comprise a substrate surface having an average oxide pore diameter of 15 to 80 nm. On this, a crosslinked hydrophilic inner layer is formed using a formulation comprising: (1) a hydrophilic polymer having recurring —CH₂—CH(OH)— units, (2) a crosslinking agent for these units having at least two aldehyde groups, and (3) an acidic compound. An oleophilic outer layer formulation comprises: (a) an infrared radiation absorber, and (b) an oleophilic polymer having at least 10 mol % randomly recurring —CH₂—CH(OH)— units, within an organic solvent solution, and dried to form a composite structure. The composite structure is heated so its surface exhibits less than 10% optical density change within a first rectangular area (width W1 and length L1) centered inside a second rectangular area (width W2 and length L2), where the surface is subjected to 1000 rubs according to ASTM D3181 using the organic solvent solution.

### FIELD OF THE INVENTION

This invention relates to a method for manufacturing lithographic printing plate precursors having at least two adhered layers on a specific anodized aluminum substrate. Such lithographic printing plate precursors can be used for lithographic printing after imaging without further treatment such as wet processing.

### BACKGROUND OF THE INVENTION

Offset lithographic printing has remained important in many areas of printing for several reasons. For continual printing methods, offset lithography has provided simplicity, cost-effectiveness, and high print quality.

Modern technology permits the generation of all kinds of digital data including images, text, and collections and arrangements of data in personal computers or other storage devices in a way that is useful in the generation of printed copy. The data are then directed to a CTP (Computer-to-Plate) device where it is used to modulate a laser (or array of lasers) that “writes” the digital data onto lithographic printing plate precursors. The resulting latent images in the precursors generally require wet processing in a developer to differentiate the regions that will accept ink from the background regions that reject ink during the printing process.

The concept of using laser energy to digitally image printing plates has closely followed the development of lasers. Early lasers were powerful but slow and expensive compared to chemical etching techniques. The laser power required at a given spot and power generated heat were both quite high. The material had to be completely vaporized for an interval sufficient to ensure its removal. Consequently, there was a great quantity of thermal energy transferred to the surrounding area that had to be removed before another spot could be etched. Clearly, the art had not progressed to the level where the thermal energy could be removed quickly enough to enable laser etching to compete in speed with chemical etching. In addition to slow production, the printing plates produced images that were unacceptably irregular and lacking in definition. A suitable exposure system would use argon ion, helium-cadmium, and other lasers of like nature to image commercially available diazo-sensitized layers on aluminum supports. The imaged printing plates were then processed using a developer.

U.S. Pat. No. 4,020,762 (Peterson) describes the use of a YAG laser to remove non-image areas, and the imaged areas were then exposed to UV light and developed using an additive developer.

U.S. Pat. No. 4,054,094 (Caddell et al.) describes the imaging of a lithographic printing plate precursor that has an aluminum base coated with a hydrophilic coating using a laser to burn away the coating and causing the aluminum surface to become oleophilic in the imaged areas leaving hydrophilic areas of the substrate. Such laser “burning” has become known as laser ablation.

An additional approach to simplification of the offset lithographic printing process is described in U.S. Pat. No. 3,511,178 (Curtin) in which the concept of waterless printing was introduced by using printing plate precursors coated with polydimethyl siloxane (silicone) that preferentially rejected ink during printing and formed the areas corresponding to the background. GB Patent Publication 1,489,308 (Eames) describes a combination of waterless printing and laser ablation.

Although the concepts described in this art were useful, in practice they created a number of problems that were not evident until later. They are expensive, slow, and require high power.

A significant advantage of using laser ablation for imaging is that as the ablated material is destroyed, minimal development is needed after imaging. Conventional lithographic printing plate making generally requires formulated processing solutions for development to wash away material in the background regions of the imaged printing plate. The use of these processing solutions has a number of problems associated with it.

Ideally, imaging by ablation should require no such processing solutions but in practice this is not the case. If the ablated printing plate could be used without the need for a cleaning process, the making of printing plates would be significantly simplified because even the simplest water washing step and processor unit could be eliminated. Even a drying step could be avoided.

Other researchers in recent years sought to produce conventional wet offset lithographic printing plate precursors that are imaged by laser ablation but the imaged precursors still require treatment to remove debris. Lithographic printing plate formulations have been specifically designed to allow for cleaning with the simplest of solutions, such as water.

U.S. Pat. Nos. 6,182,569, 6,182,570, and 6,192,798 (all Rorke et al.) describe the problems of formulations designed to accommodate post-imaging development. For example, there can be a loss of adhesion of the protective hydrophilic thermal barrier layer because too much solvent or solubilizing action by the processing solution can erode the protective layer, degrading small image areas. In these patents, it was attempted to formulate protective layers that would not be harmed by processing solutions.

U.S. Patent Application Publication 2012/0189779 (Nakash et al.) describes lithographic printing plate precursors having low sensitivities so that high imaging energy can be used. The internal portion of the oleophilic surface layer in these precursors is generally non-crosslinked. The interface of the oleophilic surface layer can be crosslinked as it is chemically bound to the underlying layer, whether it is the intermediate layer or the crosslinked hydrophilic inner layer. The ablatable oleophilic surface layer desirably has high solvent resistance but is generally non-crosslinked.

It is known to make lithographic printing plates using infrared radiation induced ablation processes where the oleophilic surface material is selectively removed and the underlying hydrophilic surface is revealed to serve as non-printing regions in a lithographic printing process. The underlying hydrophilic surface is typically made of crosslinked hydrophilic polymers that have lower heat conductivity than the grained and anodized aluminum substrate underneath these crosslinked hydrophilic polymers, and which allow more complete removal of the oleophilic material in the non-printing regions of the lithographic printing plates. However, such lithographic printing plates often suffer from poor durability on the printing press, typically in the form of a loss of the oleophilic material in the small dot areas.

There is a need to provide lithographic printing plates that exhibit improved durability on the printing press.

### SUMMARY OF THE INVENTION

This invention provides a method for preparing a positive-working lithographic printing plate precursor, the method comprising:

providing an anodized aluminum substrate comprising an anodic oxide surface having an average oxide pore diameter of at least 15 nm and up to and including 80 nm,

over the anodic oxide surface of the anodized aluminum substrate, providing a crosslinked hydrophilic inner layer by applying an inner layer formulation comprising: (1) a hydrophilic polymer that comprises randomly recurring units represented by —CH₂—CH(OH)— in an amount of at least 70 mol % of the total recurring units, (2) a crosslinking agent for the —CH₂—CH(OH)— recurring units that comprises at least two aldehyde groups, and (3) an acidic compound,

over the crosslinked hydrophilic inner layer, providing an oleophilic outer layer by applying an outer layer formulation comprising: (a) an infrared radiation absorber, and (b) at least one oleophilic polymer that comprises at least 10 mol % randomly recurring units represented by —CH₂—CH(OH)—, based on the total recurring units, dissolved or dispersed within an organic solvent solution, and drying to form a composite structure consisting of the crosslinked hydrophilic inner layer and the oleophilic outer layer, and

heating the formed composite structure such that the surface of the composite structure exhibits less than 10% optical density change within a first rectangular area defined by width W1 and length L1 centered inside a second rectangular area defined by width W2 and length L2, where the surface of the composite structure is subjected to 1000 rubs according to ASTM D3181 using the organic solvent solution, wherein W1 is 0.7 times W2, L1 is 0.7 times L2, W2 is 1.5 cm, and L2 is 12 cm.

This invention also provides a positive-working lithographic printing plate precursor prepared by the method of this invention,

wherein the lithographic printing plate comprises:

an anodized aluminum substrate comprising an anodic oxide surface having an average oxide pore diameter of at least 15 nm and up to and including 80 nm,

over the anodic oxide surface of the anodized aluminum substrate, a crosslinked hydrophilic inner layer comprising: (1) a hydrophilic polymer that comprises randomly recurring units represented by —CH₂—CH(OH)— in an amount of at least 70 mol % of the total recurring units, (2) a crosslinking agent for the —CH₂—CH(OH)— recurring units that comprises at least two aldehyde groups, and (3) an acidic compound, and

over the crosslinked hydrophilic inner layer, an oleophilic outer layer comprising: (a) an infrared radiation absorber, and (b) at least one oleophilic polymer that comprises at least 10 mol % randomly recurring units represented by —CH₂—CH(OH)—, based on the total recurring units,

the precursor further comprising a composite structure consisting of the crosslinked hydrophilic inner layer and the oleophilic outer layer,

wherein the surface of the composite structure exhibits less than 10% optical density change within a first rectangular area defined by width W1 and length L1 centered inside a second rectangular area defined by width W2 and length L2, where the surface of the composite structure is subjected to 1000 rubs according to ASTM D3181 using an organic solvent solution used to form the oleophilic outer layer, wherein W1 is 0.7 times W2, L1 is 0.7 times L2, W2 is 1.5 cm, and L2 is 12 cm.

In addition, this invention provides a method for providing a lithographic printing plate, comprising:

imagewise exposing any embodiment of the positive-working lithographic printing plate precursor described above to remove the oleophilic outer layer in exposed regions by ablation to prepare a lithographic printing plate ready for printing without further treatment or processing.

The present invention provides an improvement in methods for making lithographic printing plates using ablation for imaging. It has been found that the lithographic printing plates derived from ablative imaging, exhibit improved printing press durability. It was unexpectedly found that this improvement was provided by the use of the particular anodized aluminum substrate having the noted anodic oxide surface layer and pore diameter of at least 15 nm and up to and including 80 nm, for example as provided by phosphoric acid anodization of the aluminum substrate in combination with the noted crosslinked hydrophilic layer and oleophilic outer layer.

In addition, it was also found that the lithographic printing plate durability can be further improved by adding an acidic compound to the crosslinked hydrophilic inner layer to further improve adhesion between the crosslinked hydrophilic inner layer and the outer oleophilic layer. The oleophilic outer layer is heated after application to provide certain durability characteristics as described herein.

Further details of the advantages of the present invention will become apparent in consideration of the disclosure provided below.

### DETAILED DESCRIPTION OF THE INVENTION

### Definitions

Unless the context otherwise indicates, when used herein, the terms “positive-working lithographic printing plate precursor”, “lithographic printing plate precursor”, and “precursor” are meant to be references to embodiments of the present invention.

As used herein to define various components of the compositions, formulations, and layers, unless otherwise indicated, the singular forms “a”, “an”, and “the” are intended to include one or more of the components (that is, including plurality referents).

Each term that is not explicitly defined in the present application is to be understood to have a meaning that is commonly accepted by those skilled in the art. If the construction of a term would render it meaningless or essentially meaningless in its context, the term's definition should be taken from a standard dictionary.

The use of numerical values in the various ranges specified herein, unless otherwise expressly indicated otherwise, are considered to be approximations as though the minimum and maximum values within the stated ranges were both preceded by the word “about”. In this manner, slight variations above and below the stated ranges can be used to achieve substantially the same results as the values within the ranges. In addition, the disclosure of these ranges is intended as a continuous range including every value between the minimum and maximum values.

Unless otherwise indicated, percentages refer to percents by weight. Percent by weight can be based on the total solids in a formulation or composition, or on the total dry weight of a layer.

As used herein, the term “infrared radiation absorber” refers to a material that is sensitive to at least one peak wavelength of near infrared and infrared radiation and can convert photons into heat within the layer in which they are disposed. These compounds can also be known in the art as “photothermal conversion materials”, “sensitizers”, or “light to heat convertors”.

For clarification of definition of any terms relating to polymers, reference should be made to “Glossary of Basic Terms in Polymer Science” as published by the International Union of Pure and Applied Chemistry (“IUPAC”), Pure Appl. Chem. 68, 2287-2311 (1996). However, any different definitions set forth herein should be regarded as controlling.

Unless otherwise indicated, the term “polymer” refers to high and low molecular weight polymers including oligomers and can include both homopolymers and copolymers.

The term “copolymer” refers to polymers that are derived from two or more different monomers, or have two or more different types of recurring units, even if derived from the same monomer. Unless otherwise noted, the different constitutional recurring units are present in random order along the copolymer backbone.

The term “backbone” refers to the chain of atoms in a polymer to which a plurality of pendant groups are attached. An example of such a backbone is an “all carbon” backbone obtained from the polymerization of one or more ethylenically unsaturated polymerizable monomers. However, other backbones can include heteroatoms wherein the polymer is formed by a condensation reaction of some other means.

### Lithographic Printing Plate Precursors

The lithographic printing plate precursors prepared according to the present invention are positive-working imageable elements so that imaged (exposed) regions in the oleophilic outer layer are substantially removed during imaging and the non-imaged (non-exposed) regions of the oleophilic outer layer remain in the imaging surface of the resulting lithographic printing plate. Any debris can be removed by dry cleaning or in the fountain solution during printing.

Substrates:

The method of the present invention requires the use of an anodized aluminum substrate comprising an anodic oxide surface having an average oxide pore diameter of at least 15 nm and up to and including 80 nm, or typically at least 20 nm and up to and including 60 nm, or more likely at least 20 nm and up to and including 40 nm.

The anodized aluminum substrate generally has a hydrophilic surface that is more hydrophilic than the oleophilic outer layer on the imaging side. The substrate is usually in the form of a sheet, film, or foil, and is strong, stable, flexible, and resistant to dimensional change under conditions of use so that color records will register a full-color image.

The aluminum-containing substrates can be physically, chemically, or electrochemically grained. Following graining, the aluminum-containing substrates are anodized to provide the desired anodic oxide surface and average oxide pore diameter. Such anodization can be carried out using any suitable technique that provides these properties, but in many embodiments, the present invention comprises providing a phosphoric acid anodized aluminum substrate comprising the average oxide pore diameter of at least 15 nm and up to and including 80 nm, or of at least 20 nm and up to and including 60 nm, or typically of at least 20 nm and up to and including 40 nm.

Alternatively, the aluminum substrate can be anodized with sulfuric acid to obtain the desired anodic oxide pore size. For example, an electrochemically grained aluminum support can be anodized in an alternating current passing through a sulfuric acid solution (5-30 weight %) at a temperature of at least 20° C. and up to and including 60° C. for at least 5 seconds and up to and including 250 seconds to form an oxide layer on the metal surface. Generally, sulfuric acid anodization is carried out to provide an aluminum oxide layer of at least 0.3 g/m² and typically at least 1 g/m² and up to and including 10 g/m², or up to and including 5 g/m². The vacancy of the aluminum oxide layer can vary from at least 20% and up to and including 70%, as defined by the equation:

vacancy=(1−(density of oxide coating/3.98))×100

The sulfuric acid formed aluminum oxide layer generally has fine concave parts that are sometimes referred as “micropores” or “pores” that are distributed, perhaps uniformly, over the layer surface. The density (or vacancy) is generally controlled by properly selecting the conditions of the sulfuric acid anodization treatment. The pores can appear as columns within the aluminum oxide layer, as viewed in a cross-sectional microimage. These columnar pores can have an average diameter of less than 20 nm before they are treated to widen the average diameter at the outermost surface, or most of the columnar pores have an average diameter of at least 5 nm and up to and including 20 nm before they are treated.

According to the present invention, the electrochemically grained and sulfuric acid anodized aluminum-containing support can be treated to widen the pores in the aluminum oxide layer (“pore-widening treatment”) so that the diameter of the columnar pores at their outermost surface (that is, nearest the outermost layer surface) is at least 90%, and more typically at least 92%, and even more than 100% of the average diameter of the columnar pores. The average diameter of the columnar pores can be measured using a field emission scanning electron microscope. Once this average diameter is determined, it is possible to determine whether the diameter at the outermost surface is at least 90% of that average diameter value using similar measuring techniques.

The columnar pores can be widened using an alkaline or acidic pore-widening solution to remove at least 10 weight % and up to and including 80 weight %, typically at least 10 weight % and up to and including 60 weight %, or more likely at least 20 weight % and up to and including 50 weight %, of the original aluminum oxide layer. Pore widening can thus be accomplished using an alkaline solution containing sodium hydroxide, potassium hydroxide, lithium hydroxide, or mixtures of hydroxides, having a pH of at least 11 and up to and including 13, or more likely having a pH of at least 11.5 and up to and including 12.5, and a hydroxide (such as a sodium hydroxide) concentration of at least 0.15 g/l and up to and including 1.5 g/l. The alkaline or acidic pore-widening solution generally has conductivity of at least 0.8 mS/cm and up to and including 8.2 mS/cm.

Alternatively, one can use an acidic solution containing an inorganic acid such as sulfuric acid, phosphoric acid, hydrochloric acid, nitric acid, or mixtures of these acids at a concentration of at least 10 g/l and up to and including 500 g/l or more likely of at least 20 g/l and up to and including 100 g/l.

Particularly useful pore-widening solutions comprise sodium hydroxide, potassium hydroxide, sulfuric acid, hydrochloric acid, nitric acid, or phosphoric acid.

The pore-widening treatment with the acidic or alkaline solution can be carried out by contacting the electrochemically grained and sulfuric acid anodized support, for example by immersion in the solution, for at least 3 seconds and up to and including 300 seconds, and typically for at least 10 seconds and up to and including 120 seconds to provide columnar pores having an average diameter of at least 15 nm and up to and including 80 nm. The treatment temperature is at least 0° C. and up to and including 110° C. or typically a treatment temperature of at least 20° C. and up to and including 70° C.

Further details of these sulfuric acid anodizing and pore widening processes are provided in copending and commonly assigned U.S. Ser. No. 13/221,936, (filed Aug. 31, 2011 by Hayashi) that is incorporated herein by reference.

An optional interlayer can be formed on the anodized aluminum substrate by treating it with, for example, a silicate, dextrin, calcium zirconium fluoride, hexafluorosilicic acid, phosphate/sodium fluoride, poly(vinyl phosphonic acid) (PVPA), vinyl phosphonic acid copolymer, poly(acrylic acid), or acrylic acid copolymer solution, or an alkali salt of a condensed aryl sulfonic acid as described in GB 2,098,627 and Japanese Kokai 57-195697A (both Hefting et al.). For example, the grained and anodized aluminum substrate can be treated with a polymer derived in whole or part from acrylic acid or methacrylic acid using known procedures to improve surface hydrophilicity. For example, the hydrophilic polymer can have at least 70 mol % of randomly recurring units derived from acrylic acid, methacrylic acid, or both, based on total recurring units in the hydrophilic polymer. The dry coverage for this optional interlayer can be at least 30 mg/m² up to and including 300 mg/m².

The thickness of the anodized aluminum substrate can be varied but it should be sufficient to sustain the wear from printing and thin enough to wrap around a printing form. For example, it can have a thickness of at least 0.1 mm and to and including 0.5 mm.

The backside (non-imaging side) of the anodized aluminum-containing substrate can be coated with antistatic agents or slipping layer or matte layer to improve handling and “feel” of the positive-working lithographic printing plate precursors.

The anodized substrate can also be a cylindrical surface having the desired layers applied thereon, and thus be an integral part of the printing press. The preparation and use of such imageable cylinders is described for example in U.S. Pat. No. 5,713,287 (Gelbart) that is incorporated herein by reference.

Crosslinked Hydrophilic Inner Layer:

A crosslinked hydrophilic inner layer is provided over the anodic oxide surface of the anodized aluminum substrate by suitably applying an inner layer formulation, and suitably dried. This first essential layer in the lithographic printing plate precursor comprises one or more hydrophilic polymers, each of which comprises randomly recurring units represented by CH₂—CH(OH)— in an amount of at least 70 mol % and up to and including 100 mol %, and typically at least 70 mol % and up to and including 99.5 mol %, of the total recurring units.

For example, such hydrophilic polymers can include but are not limited to, poly(vinyl alcohol) having a hydrolysis value greater than 99%, or copolymers derived from vinyl alcohol and one or more other ethylenically unsaturated polymerizable monomers that contribute to hydrophilicity, including but not limited to acrylic acid and methacrylic acid. Mixtures of different hydrophilic polymers can be used if desired. The hydrophilic polymers are generally included within the inner layer formulation in an amount of at least 50% and up to and including 95% based on total formulation solids. The inner layer formulation is applied to the anodized aluminum substrate sufficient to provide a crosslinked hydrophilic inner layer dry coverage of at least 0.5 g/m² and up to and including 4 g/m², and typically of at least 1 g/m² and up to and including 2 g/m². The useful hydrophilic binders can be prepared using known starting materials and polymerization conditions and some may be available from commercial sources.

The inner layer formulation also comprises one or more crosslinking agents for the hydroxy groups in the one or more hydrophilic polymers, and at least one of the crosslinking agents comprises at least two aldehyde groups. Such crosslinking agents include but are not limited to, ethane-1,2-dione (also known as ethanedial), butanedial, pentane-1,5-dial, and other dialdehydes. Mixtures of such crosslinking agents can be used. A skilled worker would understand how much crosslinking agent to use based on the amount of hydrophilic polymeric binder to be crosslinked in the inner layer formulation. In general, one or more crosslinking agents are provided in the inner layer formulation in an amount of at least 2 weight % and up to and including 7% based on total solids in the inner layer formulation. Sufficient crosslinking agent is generally present to provide crosslinking at the interface of the crosslinked hydrophilic inner layer and the immediately overlying oleophilic outer layer. Crosslinking of the hydrophilic polymer generally occurs during the drying and heating stages after the layer formulations have been applied to the anodized aluminum substrate. Useful crosslinking agents can be obtained from various commercial sources.

The crosslinked hydrophilic inner layer (and the inner layer formulation used to provide it) also includes one or more acidic compounds such as an inorganic acidic compound including but not limited to phosphoric acid, sulfuric acid, and hydrochloric acid. The acidic compound such as phosphoric acid can be present in the inner layer formulation in an amount of at least 1% and up to and including 5% of total formulation solids. Such acidic compounds are readily available from commercial sources.

In addition, the crosslinked hydrophilic inner layer can include other addenda that would be useful for coating properties, adhesion to the underlying anodized aluminum substrate, or adhesion to the overlying oleophilic outer layer. Such addenda can include but are not limited to, silica, alumina, barium sulfate, titanium dioxide, kaolin, or other inorganic particulate materials, and surfactants. Infrared radiation absorbers are not purposely incorporated into the crosslinked hydrophilic inner layer, so such compounds are generally not present in the crosslinked hydrophilic inner layer, but some materials may move from the oleophilic surface layer into the crosslinked hydrophilic inner layer.

Oleophilic Outer Layer:

An oleophilic outer layer is provided over the crosslinked hydrophilic inner layer (actually, it may be only partially crosslinked at this point) using an outer layer formulation. This outer layer formulation can be applied while the inner layer formulation is still wet, or more likely, it is applied after the inner layer formulation has been at least partially dried.

The outer layer formulation (and oleophilic outer layer) comprises one or more oleophilic polymers that are generally non-crosslinked when applied, such as non-crosslinked oleophilic poly(vinyl acetal) resins comprising at least 15 mol % of randomly recurring acetal units, based on the total recurring units. The one or more oleophilic polymers are present in the outer layer formulation in an amount of at least 50% and to and including 95% based on total solids.

Each of these oleophilic resins comprises at least 10 mol % randomly recurring units represented by —CH₂—CH(OH)—, and typically at least 20 mol % and up to and including 40 mol % of such recurring units, in random order along the polymer chain, based on the total recurring units in the polymer chain.

The one or more oleophilic resins are generally dissolved in an organic solvent solution that can comprise one or more organic solvents (organic solvent mixture) including but not limited to, methyl ethyl ketone, 2-methoxy-2-propanol, 2-butoxyethanol, dihydrofiian-2(3H)-one (γ-butyrolactone), 1,3-dioxalane, N-methylpyrrolidone, and mixture of two or more of these organic solvents such as a 50:50 or 35:65 volume mixture of methyl ethyl ketone and 1-methoxy-2-propanol. A particularly useful organic solvent solution comprises methyl ethyl ketone and 1-methoxy-2-propanol in a suitable volume ratio. The organic solvent solution is used to apply the oleophilic outer layer formulation to the crosslinked hydrophilic inner layer.

In addition, each of the one or more oleophilic polymers has a weight average molecular weight (M_{W}) of generally at least 5,000 and up to and including 500,000 and typically at least 10,000 and up to and including 100,000. The optimal M_{W} can vary with the specific polymer and its use, and can be measured for example, using gel permeation chromatography.

In many embodiments, the randomly recurring acetal units in the non-crosslinked oleophilic poly(vinyl acetal) can be represented by Structure (Ia):

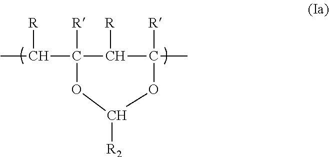

wherein R and R′ are independently hydrogen or a substituted or unsubstituted alkyl group (generally having 1 to 10 carbon atoms), a substituted or unsubstituted cycloalkyl group (having 5 to 10 carbon atoms in the ring structure), or a halo group (such as fluoro, chloro, or bromo).

R₂ can be an aryl group (such as phenyl, naphthyl, or anthryl) that is substituted with a cyclic imide group such as a cyclic aliphatic or aromatic imide group including but not limited to, maleimide, phthalimide, tetrachlorophthalimide, hydroxyphthalimide, carboxypthalimide, nitrophthalimide, chlorophthalimide, bromophthalimide, and naphthalimide groups. The aryl group of the cyclic aliphatic or aromatic imide group, or both the aryl and cyclic aliphatic or aromatic imide groups, are optionally further substituted with one or more substituents selected from the group consisting of hydroxyl, substituted or unsubstituted alkyl, substituted or unsubstituted alkoxy, and halo groups (such as fluoro and chloro), and any other group that does not adversely affect the properties of the cyclic imide group or the poly(vinyl acetal) in the oleophilic surface layer.

Alternatively, R₂ can be a nitro-substituted phenol, nitro-substituted naphthol, or nitro-substituted anthracenol. These groups can also comprise one or more other substituents as described in the previous paragraph.

The non-crosslinked oleophilic poly(vinyl acetal) can also comprise two or more different types of randomly recurring units as defined by Structure (Ia). Thus, such different recurring units can comprise different R₂ groups within the definitions provided above.

Thus, in some embodiments (a), R₂ is a phenyl or naphthyl group that has a cyclic aliphatic or aromatic imide group selected from the group consisting of maleimide, phthalimide, tetrachlorophthalimide, hydroxyphthalimide, carboxypthalimide, nitrophthalimide, chlorophthalimide, bromophthalimide, and naphthalimide groups, wherein the phenyl, naphthyl, or cyclic aliphatic or aromatic imide group is optionally further substituted with one or more substituents selected from the group consisting of hydroxyl, alkyl, alkoxy, and halo groups.

In other embodiments (b), R₂ is a nitro-substituted phenol, nitro-substituted naphthol, or nitro-substituted anthracenol.

In still other embodiments, (c) the oleophilic poly(vinyl acetal) comprises a combination of two or more different randomly recurring acetal units represented by Structure (Ia) wherein R₂ represents two or more different groups listed in (a) and (b).

In addition, the non-crosslinked oleophilic poly(vinyl acetal) can further comprise randomly recurring units represented by Structure (Ib):

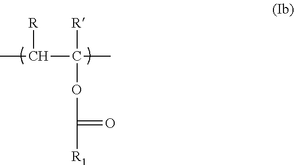

wherein R and R′ are as defined above for Structure (Ia), but they can be same or different groups for these recurring units.

R₁ is a substituted or unsubstituted linear or branched alkyl group having 1 to 12 carbon atoms (such as methyl, ethyl, n-propyl, n-butyl, n-pentyl, n-hexyl, chloromethyl, trichloromethyl, iso-propyl, iso-butyl, t-butyl, iso-pentyl, neo-pentyl, 1-methylbutyl, iso-hexyl, and dodecyl groups), a substituted or unsubstituted cycloalkyl having 5 to 10 carbon atoms in the carbocyclic ring (such as cyclopentyl, cyclohexyl, 4-methylcyclohexyl, and 4-chlorocyclohexyl), or a substituted or unsubstituted aryl group having 6 or 10 carbon atoms in the aromatic ring (such as phenyl, naphthyl, p-methylphenyl, and, p-chlorophenyl). Such groups can be substituted with one or more substituents such as alkyl, alkoxy, and halo, or any other substituent that a skilled worker would readily contemplate that would not adversely affect the performance of the polyvinyl acetal resin in the imageable element.

The non-crosslinked oleophilic poly(vinyl acetal) resins can include randomly recurring units that are selected from one or both of the recurring units represented by the following Structures (Ic) and (Id):

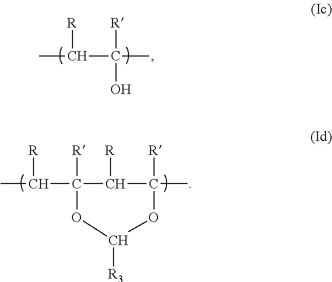

In these Structures, R and R′ are as defined above for Structure (Ia) but each recurring unit need not comprise the same R and R′ group as the other recurring units in the chain.

In Structure (Id), R₃ is hydrogen or a substituted or unsubstituted alkyl group, a substituted or unsubstituted cycloalkyl group, or an aryl group (such as phenyl, naphthyl, or anthracenyl group) that is unsubstituted or substituted with at least one hydroxy group. Thus, R₃ can have one or more hydroxy groups in the ortho, meta, or para positions relative to the aromatic carbon attached to the polymer backbone. The R₃ aryl group can have further substituents such as alkyl, alkoxy, or halo groups that do not adversely affect the properties of the aromatic group or the non-crosslinked oleophilic poly(vinyl acetal).

The non-crosslinked oleophilic poly(vinyl acetal) is generally present in the outer layer formulation (and oleophilic surface layer) in an amount of at least 50% and to and including 95%, and typically at least 60% and up to and including 75%, based on total solids.

When recurring units represented by any combination of Structures (Ia), (Ib), (Ic), and (Id) are present, in random order, the recurring units represented by Structure (Ia) can be present in an amount of at least 10 mol % and up to and including 90 mol %, the recurring units represented by (Ib) can be present in an amount of at least 2 mol % and up to and including 5 mol %, the recurring units represented by Structure (Ic) can be present in an amount of at least 5 mol % and up to and including 45 mol %, and the recurring units represented by Structure (Id) can be present in an amount of at least 2 mol % and up to and including 40 mol %, all based on the total recurring units in the poly(vinyl acetal).

The non-crosslinked poly(vinyl acetal) resins useful in the oleophilic outer layer can comprise at least recurring units represented by Structure (Ia) and recurring units represented by —CH₂—CH(OH)— in any order, and optionally recurring units represented by Structures (Ib) through (Id) but such polymers can also comprise randomly recurring units other than those defined by the illustrated recurring units and such additional recurring units would be readily apparent to a skilled worker in the art. Thus, the polymeric binders useful in the oleophilic outer layer are not limited specifically to the recurring units only defined by Structures (Ia) through (Id).

There also can be multiple types of recurring units from any of the defined classes of recurring units in Structures (Ia), (Ib), and (Id) with different substituents. For example, there can be multiple types of recurring units with different R and R′ groups, and multiple types of recurring units with different R₁, R₂, and R₃ groups. In addition, the number and type of recurring units in the oleophilic polymers are generally in random sequence, but blocks of specific recurring units can also be present unintentionally.

The oleophilic polymers useful in the outer layer formulation (and oleophilic outer layer) can be prepared using known starting materials and reaction conditions. For example, details for preparing useful oleophilic poly(vinyl acetal) resins are provided in WO04/081662 (Memetea et al.) and U.S. Pat. Nos. 6,255,033, 6,541,181, and 7,723,012 (all Levanon et al.) that are incorporated herein by reference. Other useful oleophilic polymers are available from various commercial sources.

Besides the oleophilic poly(vinyl acetal) resins described above, useful oleophilic polymers (including copolymers) include phenolic resins, polyesters, polyvinyl aromatics [such as polystyrenes and poly(hydroxystyrenes)], and mixtures thereof, or mixtures with poly(vinyl acetals), and other oleophilic polymers that exhibit desired adhesion characteristics to the underlying layer(s) and also sufficient chemical resistance to the organic solvents (described below). The best oleophilic outer layer comprises one or more poly(vinyl acetal) resins in an amount of at least 50 weight % of the total oleophilic polymers.

The outer layer formulation (and oleophilic outer layer) can also include other polymeric binders that do not meet the requirements described above as can be identified as “secondary polymeric binders”, as long as the desired properties of the oleophilic outer layer are maintained. These additional polymeric binders include but are not limited to, phenolic resins, including novolak resins such as condensation polymers of phenol and formaldehyde, condensation polymers of m-cresol and formaldehyde, condensation polymers of p-cresol and formaldehyde, condensation polymers of m-/p-mixed cresol and formaldehyde, condensation polymers of phenol, cresol (m-, p-, or m-/p-mixture) and formaldehyde, and condensation copolymers of pyrogallol and acetone. Other useful secondary polymeric binders include nitrocellulose, polyesters, and polystyrenes including poly(hydroxystyrenes).

The oleophilic outer formulation (and oleophilic outer layer) also comprises one or more infrared radiation absorbers that are typically sensitive to near-infrared or infrared radiation and have at least one peak absorption wavelength of at least 700 nm and up to and including 1500 nm and typically of at least 750 nm and up to and including 1400 nm.

Useful infrared radiation absorbers include pigments such as carbon blacks including but not limited to carbon blacks that are surface-functionalized with solubilizing groups are well known in the art. Carbon blacks that are grafted to hydrophilic, nonionic polymers, such as FX-GE-003 (manufactured by Nippon Shokubai), or which are surface-functionalized with anionic groups, such as CAB-O-JET® 200 or CAB-O-JET® 300 (manufactured by the Cabot Corporation) are also useful. Other useful carbon blacks are available from Cabot Billerica under the tradename Mogul. Other useful pigments include, but are not limited to, Heliogen Green, Nigrosine Base, iron (III) oxides, manganese oxide, Prussian Blue, and Paris Blue. The size of the pigment particles should not be more than the thickness of the oleophilic surface.

Examples of suitable IR dyes as infrared radiation absorbers include but are not limited to, azo dyes, squarylium dyes, croconate dyes, triarylamine dyes, thioazolium dyes, indolium dyes, oxonol dyes, oxazolium dyes, cyanine dyes, merocyanine dyes, phthalocyanine dyes, indocyanine dyes, indotricarbocyanine dyes, hemicyanine dyes, streptocyanine dyes, oxatricarbocyanine dyes, thiocyanine dyes, thiatricarbocyanine dyes, merocyanine dyes, cryptocyanine dyes, naphthalocyanine dyes, polyaniline dyes, polypyrrole dyes, polythiophene dyes, chalcogenopyryloarylidene and bi(chalcogenopyrylo)-polymethine dyes, oxyindolizine dyes, pyrylium dyes, pyrazoline azo dyes, oxazine dyes, naphthoquinone dyes, anthraquinone dyes, quinoneimine dyes, methine dyes, arylmethine dyes, polymethine dyes, squarine dyes, oxazole dyes, croconine dyes, porphyrin dyes, and any substituted or ionic form of the preceding dye classes. Suitable dyes are described for example, in U.S. Pat. No. 4,973,572 (DeBoer), U.S. Pat. No. 5,208,135 (Patel et al.), U.S. Pat. No. 5,244,771 (Jandrue Sr. et al.), and U.S. Pat. No. 5,401,618 (Chapman et al.), EP 0 823 327A1 (Nagasaka et al.), and U.S Patent Application Publication 2005-0130059 (Tao).

Near infrared absorbing cyanine dyes are also useful and are described for example in U.S. Pat. No. 6,309,792 (Hauck et al.), U.S. Pat. No. 6,264,920 (Achilefu et al.), U.S. Pat. No. 6,153,356 (Urano et al.), U.S. Pat. No. 5,496,903 (Watanabe et al.), and U.S. Pat. No. 4,973,572 (noted above). Suitable dyes can be formed using conventional methods and starting materials or obtained from various commercial sources including American Dye Source (Baie D'Urfe, Quebec, Canada) and FEW Chemicals (Germany).

The infrared radiation absorbers are generally present in the oleophilic outer layer at a dry coverage of at least 5 weight % and up to and including 50 weight %, or typically in an amount of at least 25 weight % and up to and including 40 weight %, based on the total oleophilic outer layer dry weight. The particular amount needed for this purpose would be readily apparent to one skilled in the art, depending upon the specific compound used. It is particularly useful to use a carbon black in the oleophilic outer layer in an amount of at least 25 weight % and up to and including 35 weight % based on the dry weight of the oleophilic outer layer.

The oleophilic outer layer can be disposed directly on the crosslinked hydrophilic inner layer. The oleophilic outer layer can be the outermost layer or there can be an overcoat layer disposed on it. In most embodiments, the oleophilic outer layer is the outermost layer of the positive-working lithographic printing plate precursor.

The oleophilic outer layer is generally bonded to the crosslinked hydrophilic inner layer at their interface in a suitable manner. Chemical bonding can be accomplished through crosslinking agents such as those that are included in the inner layer formulation as described above, and particularly ethanedial. Thus, while there can be crosslinking at the interface of the two layers, the oleophilic outer layer is generally non-crosslinked throughout the remainder of its volume. The interface of these two layers can form the composite structure described herein.

The oleophilic outer layer can also include one or more additional compounds that are colorant dyes, or UV or visible light-sensitive components. Useful colorant dyes include triarylmethane dyes such as ethyl violet, crystal violet, malachite green, brilliant green, Victoria blue B, Victoria blue R, and Victoria pure blue BO, BASONYL® Violet 610 and D11 (PCAS, Longjumeau, France). These compounds can act as contrast dyes that distinguish the non-exposed (non-imaged) regions from the exposed (imaged) regions in the lithographic printing plate. When a colorant dye is present in the oleophilic outer layer, its amount can vary widely, but generally it is present in an amount of at least 0.5 weight % and up to and including 30 weight %.

The oleophilic outer layer can also include other addenda that would be useful for coating properties, coated layer physical properties, and adhesion to the underlying layer such as small organic molecules, oligomers, and surfactants. These additives can be generally present in the oleophilic outer layer in an amount of at least 1 weight % and up to and including 30 weight %, or typically at least 2 weight % and up to and including 20 weight %. The oleophilic outer layer can further include a variety of additives including dispersing agents, humectants, biocides, plasticizers, surfactants for coatability or other properties, viscosity builders, fillers and extenders, pH adjusters, drying agents, defoamers, preservatives, antioxidants, rheology modifiers or combinations thereof, or any other addenda commonly used in the lithographic art, in conventional amounts.

The oleophilic outer layer is generally present at a dry coverage of at least 0.7 g/m² and up to and including 2.5 g/m², and typically in an amount of at least 1 g/m² and up to and including 1.5 g/m² as provided by the outer layer formulation.

### Preparation of Lithographic Printing Plate Precursors

The positive-working lithographic printing plate precursors can be prepared by applying an inner layer formulation (as described above) in suitable solvents to the surface of the anodized aluminum substrate (and any other hydrophilic layers provided thereon) using conventional coating or lamination methods. Thus, the inner layer formulation can be applied by dispersing or dissolving the desired components (for example hydrophilic polymers, crosslinking agents, and acidic compounds) in one or more suitable coating solvents. The resulting inner layer formulation can be applied to the anodized aluminum substrate using suitable equipment and procedures, such as spin coating, knife coating, gravure coating, die coating, slot coating, bar coating, wire rod coating, roller coating, or extrusion hopper coating. The inner layer formulation can also be applied by spraying onto a suitable anodized aluminum substrate (such as an on-press printing anodized aluminum cylinder).

The selection of solvents used to coat the inner layer formulation depends upon the nature of the hydrophilic polymeric binders, crosslinking agents, acidic compounds, and any other material used in the formulation. Generally, the inner layer formulation is coated out of one or more solvents that can dissolve the hydrophilic polymers including but not limited to, water, water-miscible alcohols, and ketones such as acetone, and mixtures thereof.

The outer oleophilic layer formulation can be prepared by dissolving or dispersing the one or more oleophilic polymers, an infrared radiation absorber, and any optional addenda in suitable organic solvent solution including but not limited to, acetone, methyl ethyl ketone, or another ketone, tetrahydrofuran, 1-methoxy-2-propanol, N-methylpyrrolidone, 1-methoxy-2-propyl acetate, γ-butyrolactone, 1,3-dioxalane, and mixtures thereof using conditions and techniques well known in the art. After application of the outer layer formulation to the dried crosslinked hydrophilic inner layer, the outer layer formulation is also dried. Optionally, the resulting lithographic printing plate precursor can be further heated immediately after the drying or at a later stage. Drying and the optional additional heating process encourage adhesion (and crosslinking) of the oleophilic outer layer to the crosslinked hydrophilic inner layer to form the composite structure consisting of the two layers.

Representative methods for preparing positive-working imageable elements are described below in the examples. For example, after all of the layer formulations are dried on the anodized aluminum substrate (that is, the coatings are dry to the touch), the lithographic printing plate precursor can be heated to facilitate crosslinking, especially between the oleophilic outer layer and the hydrophilic inner layer. Alternatively, this heating (generally using higher temperatures than used in the drying step) can be combined with the drying step into a single drying/heating step at a high enough temperature to obtain desired adhesion between the applied layers.

This heating can be carried out in a variety of ways as described below such that upon heating the formed composite structure and in particular the oleophilic outer layer, exhibits less than 10% optical density change within a first rectangular area defined by width W1 and length L1 centered inside a second rectangular area defined by width W2 and length L2, where the surface of the composite structure is subjected to 1000 rubs according to ASTM D3181 using the organic solvent solution used to coat or apply the oleophilic outer layer formulation, wherein W1 is 0.7 times W2, L1 is 0.7 times L2, W2 is 1.5 cm, and L2 is 12 cm. In particular, upon the heat treatment, the composite structure exhibits less than 10% (preferred) optical density change within the first rectangular area.

Optical density change can be measured by using a densitometer such as a SpectroDens (available from Techkon, Germany).

ASTM D3181 is a standard guide for conducting wear test on textiles that was adapted for testing the relative adhesion strengths of the outer oleophilic layer (formulation) to the crosslinked inner hydrophilic layer in the lithographic printing plate precursors. This test generally includes determining the comparative performance of a precursor after it has been rubbed for a given number of times. This can be carried out conveniently with a Crockmeter and the level of wear that is observed can be evaluated with the unaided eye or in a more quantitative way, such as using a densitometer, as described below in the rubbing tests section.

In these rubbing tests, a sample of a lithographic printing plate precursor is placed in a Crockmeter that has a “finger” that is wrapped with a cloth soaked with a solvent (for example a PM/MEK mixture shown in the Invention Examples below). This wrapped “finger” moves back and forth across the surface of the precursor for a given number of times (as indicated in the Invention Examples below) causing wear to the oleophilic outer layer.

Some specific heating protocols to achieve the desired adhesion of the layers in the precursor are as follows:

1. After drying the lithographic printing plate precursor for 1 minute at 100° C., it is then further heated for 75 seconds at 240° C. in a suitable oven. An example of a useful oven is a Wisconsin oven that was used in the Invention Examples described below.

2. Drying and heating the lithographic printing plate precursor in one step for 75 seconds at 240° C. in a suitable oven (such as a Wisconsin oven).

3. After drying the lithographic printing plate precursor, it is then further heated for 2 seconds with a short wave IR lamp that can generate suitable irradiation power. A useful example of this process is the use of the short wave IR lamp shown in Invention Example 12 that can generate up to 75 W/cm and that was operated such that it irradiated at 70% of its maximum power. In Invention Example 12, the IR lamp was placed 9.5 cm above the precursor but a combination of distance and irradiation power can be adjusted as needed.

While these three procedures are particularly useful, a skilled worker in the art would be able to use the teaching provided in this disclosure to carry out other suitable drying, heating, or drying/heating procedures to achieve the desired results in the precursors of the present invention.

The lithographic printing plate precursors of this invention can be stored or shipped to a user in appropriate containers as stacks of multiple precursors, such as at least 10 precursors or even at least 50 precursors and up to 1000 precursors. A suitable interleaf sheet can be provided between adjacent precursors as well as between the topmost precursor in the stack and the outer packaging material. Such interleaf sheets can have the same or different coefficient of friction values on opposing sides.

### Imaging and Printing

The lithographic printing plate precursors of the present invention are useful for forming lithographic printing plates. The lithographic printing plate precursors can be of any useful size and shape (for example, square or rectangular) having the requisite layers disposed on a suitable anodized aluminum substrate having the desired average anodic oxide pore diameter.

During use, the lithographic printing plate precursors are exposed to a suitable source of radiation such as near-IR and infrared radiation, depending upon the infrared radiation absorber that is present in the oleophilic outer layer, for example at a wavelength of at least 700 and up to and including 1500 nm. For most embodiments, imaging is carried out using an infrared or near-infrared laser at a wavelength of at least 700 and up to and including 1200 nm. The laser used to expose the imaging member can be a diode laser, because of the reliability and low maintenance of diode laser systems, but other lasers such as gas or solid-state lasers may also be used. The combination of power, intensity and exposure time for laser imaging would be readily apparent to one skilled in the art.

The imaging apparatus can function solely as a platesetter or it can be incorporated directly into a lithographic printing press. Printing can commence immediately after imaging without contact with any solutions. The imaging apparatus can be configured as a flatbed recorder or as a drum recorder, with the lithographic printing plate precursor mounted to the interior or exterior cylindrical surface of the drum. A useful imaging apparatus is available as models of Kodak Trendsetter imagesetters available from Eastman Kodak Company (Burnaby, British Columbia, Canada) that contain laser diodes that emit near infrared radiation at a wavelength of about 830 nm. Other suitable imaging sources include the Crescent 42T Platesetter that operates at a wavelength of 1064 nm (available from Gerber Scientific, Chicago, Ill.) and the Screen PlateRite 4300 series or 8600 series platesetter (available from Screen, Chicago, Ill.). Additional useful sources of radiation include direct imaging presses that can be used to image an element while it is attached to the printing plate cylinder. An example of a suitable direct imaging printing press includes the Heidelberg SM74-DI press (available from Heidelberg, Dayton, Ohio).

In some embodiments, the infrared radiation exposure energy can be at least 1 J/cm², or typically of at least 1 J/cm² and up to and including 4 J/cm², but higher imaging energies are also possible.

While laser imaging is usually practiced, imaging can be provided by any other means that provides thermal energy in an imagewise fashion. For example, imaging can be accomplished using a thermoresistive head (thermal printing head) in what is known as “thermal printing”, described for example in U.S. Pat. No. 5,488,025 (Martin et al.). Thermal print heads are commercially available (for example, as Fujitsu Thermal Head FTP-040 MCS001 and TDK Thermal Head F415 HH7-1089).

Imaging is generally carried out using direct digital imaging. The image signals are stored as a bitmap data file on a computer. Such data files may be generated by a raster image processor (RIP) or other suitable means. The bitmaps are constructed to define the hue of the color as well as screen frequencies and angles.

Imaging of the lithographic printing plate precursor produces a latent image of imaged (ablated) and non-imaged (non-ablated) regions. Substantially the entire oleophilic outer layer and perhaps a small portion of the crosslinked hydrophilic inner layer are ablated or physically removed in the imaged regions during imaging.

The ablated material from imaged regions in the one or more layers can be removed from the imaged lithographic printing plate precursor and its environment using known means such as vacuum, or wiping with a dry or moist cloth (for example, dry cleaning) before the imaged precursor is used for printing. In particular, the ablated image on the imaged precursor can be dry cleaned before being used for lithographic printing. In other embodiments, the ablated image is used for lithographic printing without dry cleaning and without intermediate contact with any solution. An important aspect of this invention is that wet processing such as development with water or a developer solution, gumming, or water rinsing is not required before the imaged precursor is used for lithographic printing. Thus, it is an important advantage that lithographic printing can be carried out immediately after the lithographic printing plate precursor is imaged by ablation.

During the practice of the method of the present invention, ablation so completely removes the oleophilic outer layer that very little debris (trace amounts) in the form of very small particles are left due to electrostatic attraction to the oleophilic outer surface of the lithographic printing plate. These small particles can be removed during printing in the on-press fountain solution and lithographic printing ink. The background in printed images is very clear at the beginning of the print run. Thus, with the present invention, it is possible to achieve literally processless lithographic printing plates using ablation for imaging.

The imaged lithographic printing plates of this invention can be used for lithographic printing on any suitable printing apparatus using known fountain solutions and lithographic printing inks for as many impressions that are desired. The lithographic printing plate can be used in a single printing run for its entire printing life, or printing can be stopped and the printing plate can be cleaned before resuming lithographic printing.

The present invention provides at least the following embodiments and combinations thereof, but other combinations of features are considered to be within the present invention as a skilled artisan would appreciate from the teaching of this disclosure:

1. A method for preparing a positive-working lithographic printing plate precursor, the method comprising:

providing an anodized aluminum substrate comprising an anodic oxide surface having an average oxide pore diameter of at least 15 nm and up to and including 80 nm,

over the anodic oxide surface of the anodized aluminum substrate, providing a crosslinked hydrophilic inner layer by applying an inner layer formulation comprising: (1) a hydrophilic polymer that comprises randomly recurring units represented by —CH₂—CH(OH)— in an amount of at least 70 mol % of the total recurring units, (2) a crosslinking agent for the —CH₂—CH(OH)— recurring units that comprises at least two aldehyde groups, and (3) an acidic compound,

over the crosslinked hydrophilic inner layer, providing an oleophilic outer layer by applying an outer layer formulation comprising: (a) an infrared radiation absorber, and (b) at least one oleophilic polymer that comprises at least 10 mol % randomly recurring units represented by —CH₂—CH(OH)—, based on the total recurring units, dissolved or dispersed within an organic solvent solution, and drying to form a composite structure consisting of the crosslinked hydrophilic inner layer and the oleophilic outer layer, and

heating the formed composite structure such that the surface of the composite structure exhibits less than 10% optical density change within a first rectangular area defined by width W1 and length L1 centered inside a second rectangular area defined by width W2 and length L2, where the surface of the composite structure is subjected to 1000 rubs according to ASTM D3181 using the organic solvent solution, wherein W1 is 0.7 times W2, L1 is 0.7 times L2, W2 is 1.5 cm, and L2 is 12 cm.

2. The method of embodiment 1, wherein the oleophilic polymer is a poly(vinyl acetyl) comprising at least 15 mol % of randomly recurring acetal units, based on the total recurring units.

3. The method of embodiment 1 or 2, comprising providing a phosphoric acid anodized aluminum substrate comprising the average oxide pore diameter of at least 20 nm and up to and including 60 nm.

4. The method of any of embodiments 1 to 3, comprising providing a phosphoric acid anodized aluminum substrate comprising the average oxide pore diameter of at least 20 nm and up to and including 40 nm.

5. The method of any of embodiments 1 to 4, wherein the oleophilic polymer comprises randomly recurring acetal units that are represented by Structure (Ia):

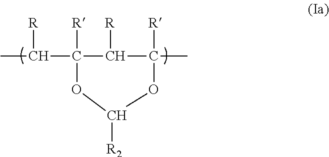

wherein R and R′ are independently hydrogen or a substituted or unsubstituted alkyl group, a substituted or unsubstituted cycloalkyl group, or a halo group,

a) R₂ is a phenyl or naphthyl group that has a cyclic aliphatic or aromatic imide group selected from the group consisting of maleimide, phthalimide, tetrachlorophthalimide, hydroxyphthalimide, carboxypthalimide, nitrophthalimide, chlorophthalimide, bromophthalimide, and naphthalimide groups, wherein the phenyl, naphthyl, or cyclic aliphatic or aromatic imide group is optionally further substituted with one or more substituents selected from the group consisting of hydroxyl, alkyl, alkoxy, and halo groups,

b) R₂ is a nitro-substituted phenol, nitro-substituted naphthol, or nitro-substituted anthracenol, or

c) the oleophilic poly(vinyl acetal) comprises a combination of two or more different randomly recurring acetal units represented by Structure (Ia) wherein R₂ represents two or more different groups listed in a) and b).

6. The method of embodiment 5, wherein the oleophilic polymer is a poly(vinyl acetal) that also comprises randomly recurring units represented by Structure (Ib):

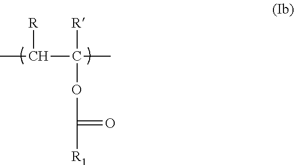

wherein R and R′ are independently hydrogen or a substituted or unsubstituted alkyl group, a substituted or unsubstituted cycloalkyl group, or a halo group, and R₁ is a substituted or unsubstituted linear or branched alkyl group having 1 to 12 carbon atoms, a substituted or unsubstituted cycloalkyl having 5 to 10 carbon atoms in the carbocyclic ring, or a substituted or unsubstituted aryl group having 6 or 10 carbon atoms in the aromatic ring.

7. The method of any of embodiments 1 to 6, wherein the oleophilic polymer further comprises randomly recurring units represented by one or both of the following Structures (Ic) and (Id):

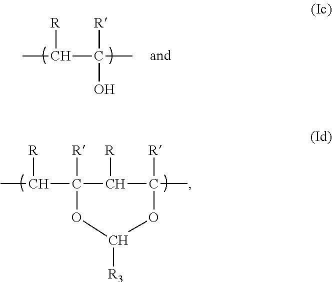

wherein R and R′ are independently hydrogen or a substituted or unsubstituted alkyl group, a substituted or unsubstituted cycloalkyl group, or a halo group,

R₃ is hydrogen or a substituted or unsubstituted alkyl group, a substituted or unsubstituted cycloalkyl group, or an aryl group that is unsubstituted or substituted with at least one hydroxy group.

8. The method of any of embodiments 1 to 7, wherein the hydrophilic polymer is a poly(vinyl alcohol) that is present in the inner layer formulation in an amount of at least 50% solids.

9. The method of any of embodiments 1 to 8, wherein the crosslinking agent is ethane-1,2-tiol that is present in the inner layer formulation in an amount of at least 2% based on total formulation solids.

10. The method of any of embodiments 1 to 9, wherein the acidic compound is phosphoric acid that is present in the inner layer formulation in an amount of at least 1% based on the total formulation solids.

11. The method of any of embodiments 1 to 10, wherein prior to applying the inner layer formulation, treating the anodic oxide surface layer with a hydrophilic polymer having at least 70 mol % randomly recurring units derived from acrylic acid, methacrylic acid, or both.

12. The method of any of embodiments 1 to 11, wherein the oleophilic polymer is present in the outer layer formulation in an amount of at least 50% and to and including 95% based on total solids.

13. The method of any of embodiments 1 to 12, wherein the surface layer formulation comprises an infrared radiation absorber that is a carbon black.

14. The method of any of embodiments 1 to 13, comprising:

applying the inner layer formulation to provide a dry coverage of at least 0.5 g/m² and up to and including 4 g/m², and

applying the outer layer formulation to provide a dry coverage of at least 0.7 g/m² and up to and including 2.5 g/m².

15. A positive-working lithographic printing plate precursor prepared by the method of any of embodiments 1 to 14,

wherein the lithographic printing plate comprises:

an anodized aluminum substrate comprising an anodic oxide surface having an average oxide pore diameter of at least 15 nm and up to and including 80 nm,

over the anodic oxide surface of the anodized aluminum substrate, a crosslinked hydrophilic inner layer comprising: (1) a hydrophilic polymer that comprises randomly recurring units represented by —CH₂—CH(OH)— in an amount of at least 70 mol % of the total recurring units, (2) a crosslinking agent for the —CH₂—CH(OH)— recurring units that comprises at least two aldehyde groups, and (3) an acidic compound, and

over the crosslinked hydrophilic inner layer, an oleophilic outer layer comprising: (a) an infrared radiation absorber, and (b) at least one oleophilic polymer that comprises at least 10 mol % randomly recurring units represented by —CH₂—CH(OH)—, based on the total recurring units,

the precursor further comprising a composite structure consisting of the crosslinked hydrophilic inner layer and the oleophilic outer layer,

wherein the surface of the composite structure exhibits less than 10% optical density change within a first rectangular area defined by width W1 and length L1 centered inside a second rectangular area defined by width W2 and length L2, where the surface of the composite structure is subjected to 1000 rubs according to ASTM D3181 using an organic solvent solution used to form the oleophilic outer layer, wherein W1 is 0.7 times W2, L1 is 0.7 times L2, W2 is 1.5 cm, and L2 is 12 cm.

16. A method for providing a lithographic printing plate, comprising:

imagewise exposing the positive-working lithographic printing plate precursor of embodiment 14 to remove the oleophilic outer layer in exposed regions by ablation to prepare a lithographic printing plate ready for printing without further treatment or processing.

17. The method of embodiment 16, wherein the imagewise exposing is carried out using infrared radiation at an energy of at least 1 J/cm².

18. The method of embodiment 16 or 17, wherein without intermediate contact with a solution after the imagewise exposing, using the lithographic printing plate for lithographic printing.

The following Examples are provided to illustrate the practice of this invention and are not meant to be limiting in any manner. In these examples, the following components were used to prepare the lithographic printing plate precursors. Unless otherwise indicated, the components are available from Aldrich Chemical Company (Milwaukee, Wis.):

BF-03 represents a poly(vinyl alcohol), 98% hydrolyzed (Mw=15,000) that was obtained from Chang Chun Petrochemical Co. Ltd. (Taiwan).

Celvol® 125 is a poly(vinyl alcohol), 99.3% hydrolyzed, average molecular weight 124,000 that can be obtained from Celanese Chemicals.

DMSO represents dimethylsulfoxide.

The glyoxal solution was a 40 weight % solution of ethanedial in water (available from Sigma Aldrich Company).

MEK represents methyl ethyl ketone.

Mogul® L is a carbon black powder that can be obtained from Cabot Billerica.

MSA represents methanesulfonic acid (99%, Sigma Aldrich Company).

PM represents 1-methoxy-2-propanol, can be obtained as Arcosolv® PM (Lyondell).

TEA represents triethanolamine.

A carboxy-substituted 4-phthalimidobenzaldehyde, IUPAC name 2-(4-formylphenyl)-1,3-dioxoisoindoline-5-carboxylic acid (Compound I) was prepared as follows:

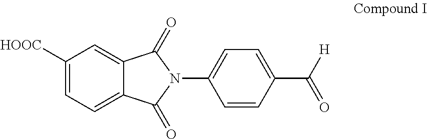 [SMILES: O=Cc1ccc(N2C(=O)c3ccc(C(=O)O)cc3C2=O)cc1]

4-Aminobenzaldehyde (10 g) and 1,2,4-benzenetricarboxylic anhydride (15.86 g) were added to a 500 ml round bottom glass vessel equipped with a magnetic stirrer. Then, 350 g of acetic acid was added to the reaction vessel. The mixture was heated to the reflux while being stirred for 8 hours. The reaction mixture was chilled to room temperature. The precipitated product was filtered off, washed on the filter with water and alcohol, and dried. The yield of Compound I was 80% with m.p. of 317° C.

### Preparation of Polymer MN-24

BF-03 (10.14 g) was added to a reaction vessel fitted with a water-cooled condenser, a dropping funnel and thermometer, containing DMSO (140 g). With continual stirring, the mixture was heated for 30 minutes at 80° C. until it became a clear solution. The temperature was then adjusted at 60° C. and MSA (0.88 g) was added. 2-(4-formylphenyl)-1,3-dioxoisoindoline-5-carboxylic acid (10.00 g) in DMSO (20 g) was added to the reaction mixture and it was kept for 150 minutes at 85° C. Then, 2-hydroxy-5-nitro benzaldehyde (5-nitro-salicylic aldehyde, 8.87 g) and DMSO (20 g) were added to the reaction mixture that was then kept for 1 hour at 85° C. The reaction mixture was then diluted with DMSO (40 g) and anisole (55 g) and vacuum distillation was started. The anisole:water azeotrope was distilled out from the reaction mixture (less than 0.1% of water remained in the solution). The reaction mixture was chilled to room temperature and was neutralized with TEA (1 g) dissolved in DMSO (90 g), then blended with 1.8 kg of water. The resulting precipitated polymer was washed with water, filtered, and dried in vacuum for 24 hours at 60° C. to obtain 25.2 g of dry Polymer MN-24 (see the following polymeric structure in Scheme 1).

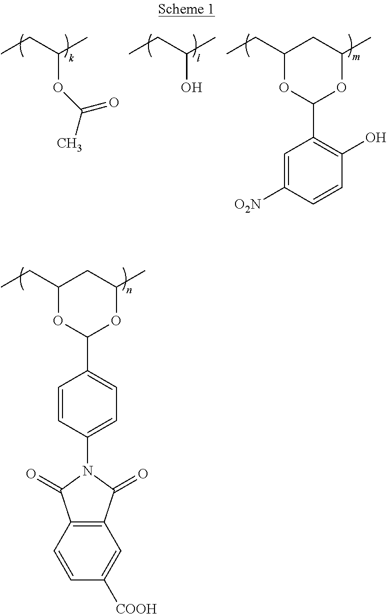

The polymer binder MN-24 was derived from poly(vinyl alcohol) using 2% original acetate and its free OH groups were converted to acetals of carboxy substituted 4-phthalimidobenzaldehyde and 5-nitrosalicylic aldehyde at 30%, and 47%, respectively.

The lithographic printing plate precursors prepared according to this invention comprised an infrared radiation-sensitive oleophilic outer layer applied to a crosslinked hydrophilic inner layer that had been applied to a phosphoric acid anodized aluminum substrate as described below, or to a sulfuric acid anodized aluminum substrate that had columnar pores in the anodized layer that had been widened with an alkaline solution as described in U.S. Ser. No. 13/221,936 (noted above).

### Invention Example 1

Positive-working lithographic printing plate precursors were prepared according to the present invention using the inner layer formulation containing the following components:

| Hydrophilic Inner Layer | | |
|---|---|---|
| Formulation | Weight (g) | Dry Weight % |
| Celvol ® 125* | 84.503 | 94.5 |
| Glyoxal solution** | 0.497 | 5.5 |

*4 weight % of PVA in water
**40 weight % of Glyoxal in water

This hydrophilic inner layer formulation was applied to an electrochemically roughened and phosphoric acid anodized aluminum substrate that had been subjected to post-treatment with an aqueous solution of poly(acrylic acid) using known procedures and the coating was dried for 1 minutes at 120° C. in an oven to provide a dry hydrophilic layer coating weight of about 1.7 g/m². Onto this dried layer was coated an outer layer formulation that was prepared by milling for 3 days (with metal balls) the outer layer formulation containing the following components (of Part A) that were then diluted with the solvents mixture of part B:

| Oleophilic Outer Layer | | |
|---|---|---|
| Formulation | Weight (g) | Dry Weight % |
| Part A - Milled base | | |
| Polymer MN-24 | 4.053 | 65 |
| MEK | 8.709 | 0 |
| PM | 16.175 | 0 |
| Mogul ® L carbon black | 2.182 | 35 |
| Part B - Solvents added to | | |
| Part A after milling | | |
| MEK | 7.911 | 0 |
| PM | 14.692 | 0 |

The oleophilic outer layer formulation was dried for 1 minute at 100° C. in an oven to provide a dry oleophilic outer layer coating weight of about 1.4 g/m².

Both hydrophilic inner layer and oleophilic outer layer were then further heated for 75 seconds at 240° C. in an oven, causing further crosslinking between the two layers.

The lithographic printing plate precursors were exposed at 1500 mJ/cm² with a Kodak® Lotem 400 Quantum imager (having 1 bar of diodes, 224 valves and overall intensity of 25 Watt). The exposed precursors were gently wet cleaned with water, removing the black material still left on the imaged background. The resulting lithographic printing plates were then mounted on a Ryobi 520HX press and 140,000 impressions were made showing good image quality. Wear of more than 20% reduction in printed dots size of fine features (5% dots at 200 lpi screen) was seen only after about 120,000 impressions. A white printed background was obtained, corresponding to a fully imaged area on the lithographic printing plate. This was observed already from the beginning of the print test. On the other hand, when the imaged precursor was mounted on the printing press without first water cleaning it, the white printed background was obtained only after about 50 impressions. That is, the black material left on the imaged background was removed on the printing press during printing, and so in this case the lithographic printing plate was developed on press.

However, when the precursor was imaged with a more powerful laser of a Kodak® Thermo Flex 400 imager (having 48 diodes of 1 Watt each), the imaged areas on the precursor were almost completely clean after imaging (only trace amounts of debris left in the imaged background). In this embodiment, the lithographic printing plate was not cleaned after imaging and the trace amounts of debris left on the printing plate after imaging were easily removed by the fountain solution on the printing press. Indeed, fully imaged areas that were not cleaned printed white background, and this was observed from the beginning of the print test. Therefore, in these embodiments, it is possible to achieve literally processless lithographic printing plates by ablation.

This Inventive lithographic printing plate exhibited a much improved print run length compared to that described in Comparative Example 1. This suggests that the phosphoric acid anodized aluminum substrate used in Invention Example 1 provided a much better image adhesion compared to the use of a sulfuric acid anodized aluminum substrate used in Comparative Example 1.

Without being bound to a particular mechanism or explanation, this improvement could be due to the very different topography of the two different anodized aluminum substrates that were observed in scanning electron micrographs of the two substrates. Contrary to the sulfuric acid anodized aluminum substrate used in Comparative Example 1, the phosphoric acid anodized aluminum substrate used in Invention Example 1 had hollow deep channels going through the anodic oxide surface of the aluminum. It could be that in this situation, the hydrophilic inner layer formulation (comprising Celvol® 125 and glyoxal) was able to better penetrate into the phosphoric acid anodized aluminum anodic surface, thus improving the adhesion of the resulting hydrophilic inner layer to the substrate and also improving the resulting image, leading to a much improved print run length.

### Invention Example 2

Lithographic printing plate precursors were prepared according to the present invention by using the same general procedure described above for Invention Example 1, but the electrochemically roughened and phosphoric acid anodized aluminum substrate was not subjected to a post treatment with an aqueous solution of poly acrylic acid.

The resulting lithographic printing plate precursors were exposed at 1500 mJ/cm² with a Kodak® Lotem 400 Quantum imager (having 1 bar of diodes, 224 valves and overall intensity of 25 Watt). The imaged precursors were gently wet cleaned with water, removing the black material still left on the imaged background. The resulting lithographic printing plates were then mounted on a Ryobi 520HX press and 130,000 impressions were made showing good image quality. Wear of more than 20% reduction in printed dots size of fine features (5% dots at 200 lpi screen) was seen only after about 90,000 impressions. A white printed background was obtained, corresponding to a fully imaged area on the lithographic printing plate, as observed from the beginning of the print test.

On the other hand, when the imaged printing plate was mounted on a printing press without first water cleaning it, the white printed background was obtained only after about 50 impressions. That is, the black material left on the imaged background was removed on the printing press during printing and so in this embodiment, the imaged precursor was developed on the printing press.

However, when the lithographic printing plate was imaged with a more powerful laser of a Kodak® Thermo Flex 400 imager (having 48 diodes of 1 Watt each), the imaged areas on the lithographic printing plate were almost completely clean after imaging (only trace amounts of debris left in the imaged background). In this embodiment, the printing plate was not cleaned after imaging and the trace amounts of debris left on the lithographic printing plate after imaging were easily removed by the fountain solution on the printing press. Indeed, fully imaged areas that were not cleaned, printed white background, and this was observed from the beginning of the print test. Therefore, in these embodiments, it is possible to achieve literally processless lithographic printing plates by ablation.

The print run length obtained with the lithographic printing plate of Invention Example 2 was somewhat shorter than that obtained with the lithographic printing plate of Invention Example 1. This suggests that the poly(acrylic acid) layer from the post treatment can further improve the print run length. On the other hand, the print run length obtained with the lithographic printing plate of Invention Example 2 is much improved compared to that obtained in Comparative Example 1. This suggests that it is not the post treatment of the substrate that is responsible for the significant difference in image adhesion and print run length. As explained above for Invention Example 1, it is likely that the very different topography of the anodized aluminum substrates used in Invention Examples 1 and 2, compared to that of the substrate used in Comparative Example 1, provides a much improved image adhesion and print run length.

### Invention Example 3

Lithographic printing plate precursors were prepared according to this invention using the same general procedure described above for Invention Example 1, but the oleophilic outer layer, was dried after coating for 1 minute at 100° C. in an oven and then the resulting lithographic printing plate precursor was further heated for 4 hours at 170° C. in an oven.

The lithographic printing plate precursors were exposed at 1500 mJ/cm² with a Kodak® Lotem 400 Quantum imager (having 1 bar of diodes, 224 valves and overall intensity of 25 Watt). The imaged precursors were gently wet cleaned with water, removing the black material still left on the imaged background. The resulting lithographic printing plates were then mounted on a Ryobi 520HX press and 100,000 impressions were made showing good image quality. Wear of more than 20% reduction in printed dots size of fine features (5% dots at 200 lpi screen) was seen only after about 80,000 impressions. A white printed background was obtained, corresponding to a fully imaged area on the lithographic printing plate as observed from the beginning of the print test.

On the other hand, when the imaged precursor was mounted on a printing press without first water cleaning it, the white printed background was obtained only after about 50 impressions. That is, the black material left on the imaged background was removed on the printing press during printing and so in this case the image precursor was developed on the printing press.

However, when the lithographic printing plate precursors were imaged with a more powerful laser of a Kodak® Thermo Flex 400 imager (having 48 diodes of 1 Watt each), the imaged areas on the imaged precursor were almost completely clean after imaging (only trace amounts of debris left in the imaged background). In these embodiments, the imaged precursors were not cleaned after imaging and the trace amounts of debris left on the lithographic printing plates after imaging were easily removed by the fountain solution on the printing press during printing. Indeed, fully imaged areas that were not cleaned, printed white background, as observed from the beginning of the print test. Therefore, in these embodiments, it is possible to achieve literally processless lithographic printing plates by ablation.

The print run length obtained with the lithographic printing plates of Invention Example 3 was shorter than that obtained with the lithographic printing plates of Invention Example 1. This suggests that heating the lithographic printing plate precursors at a higher temperature for a shorter duration of time (75 seconds at 240° C. as in Invention Example 1) can lead to better image adhesion than when heating is carried out at a lower temperature for relatively long duration of time (4 hours at 170° C. as in Invention Example 3).

In addition, the print run length obtained with the lithographic printing plates of Invention Example 3 was much improved compared to that described for Comparative Example 2. As explained above for Invention Example 1, it is likely that the very different topography of the phosphoric acid anodized aluminum substrates used in Invention Example 3, compared to that of the sulfuric acid anodized substrate used in Comparative Example 2, can lead to the much improved image adhesion and print run length.

### Invention Example 4

Lithographic printing plate precursors were prepared according to this invention using the same general procedure described above for Invention Example 1, but the oleophilic outer layer, was dried after coating for 1 minute at 100° C. in an oven and then the precursors were further heated for 2 hours at 170° C. in an oven.

The lithographic printing plate precursors were exposed at 1500 mJ/cm² with a Kodak® Lotem 400 Quantum imager (having 1 bar of diodes, 224 valves and overall intensity of 25 Watt). The imaged precursors were gently wet cleaned with water, removing the black material still left on the imaged background. The imaged precursors were then mounted on a Ryobi 520HX press and 100,000 impressions were made showing good image quality. Wear of more than 20% reduction in printed dots size of fine features (5% dots at 200 lpi screen) was seen only after about 60,000 impressions. A white printed background was obtained, corresponding to a fully imaged area on the lithographic printing plate as observed from the beginning of the print test.

On the other hand, when the imaged precursors were mounted on the printing press without first water cleaning it, the white printed background was obtained only after about 50 impressions. That is, the black material left on the imaged background was removed on the printing press and in these embodiments the imaged precursors were developed on the printing press.

However, when the lithographic printing plate precursors were imaged with a more powerful laser of a Kodak® Thermo Flex 400 imager (having 48 diodes of 1 Watt each), the imaged areas on the imaged precursors were almost completely clean after imaging (only trace amounts of debris left in the imaged background). In these embodiments, the imaged precursors were not cleaned after imaging and the trace amounts of debris left after imaging were easily removed by the fountain solution on the printing press. The fully imaged areas that were not cleaned, printed white background as observed from the beginning of the print test. Therefore, in these embodiments, it is possible to achieve literally processless lithographic printing plates by ablation.

The print run length obtained with the lithographic printing plates of Invention Example 4 was shorter than that obtained with the lithographic printing plates of Invention Example 3. This suggests that heating the lithographic printing plate precursors for a longer duration of time (4 hours at 170° C. in Invention Example 3) provides better image adhesion than when heating for a relatively shorter duration of time (2 hours at 170° C. in Invention Example 4).

In addition, the print run length obtained with the lithographic printing plates of Invention Example 4 was much improved compared to that obtained in Comparative Example 3. As explained above for Invention Example 1, it is likely that the very different topography of the phosphoric acid anodized substrates used in Invention Examples 4, compared to that of the sulfuric acid anodized substrate used in Comparative Example 3, provided much improved image adhesion and print run length.

### Invention Example 5

Lithographic printing plate precursors of this invention were prepared using the same general procedure described above for Invention Example 1, but phosphoric acid was added to the crosslinked hydrophilic inner layer. Thus, the hydrophilic inner layer formulation used to provide this layer contained the following components:

| Hydrophilic Inner Layer | Weight | Dry Weight |
|---|---|---|
| Formulation | (g) | (%) |
| Celvol ® 125* | 39.133 | 93.03 |
| Glyoxal solution** | 0.230 | 5.47 |
| Phosphoric acid solution*** | 0.030 | 1.50 |
| Water | 0.607 | 0 |

*4 weight % of PVA in water
**40 weight % of Glyoxal in water
***85 weight % of phosphoric acid in water

As in Invention Example 1, the formulation was applied to an electrochemically roughened and phosphoric anodized aluminum substrate that was subjected to an after treatment using an aqueous solution of poly acrylic acid by means of common methods and the coating was dried for 1 minute at 120° C. in an oven. The weight of the dry crosslinked hydrophilic inner layer was about 1.7 g/m². The oleophilic outer layer formulation was applied as described in Invention Example 1.

The resulting lithographic printing plate precursors were exposed at 1500 mJ/cm² using a Kodak® Lotem 400 Quantum imager (having 1 bar of diodes, 224 valves and overall intensity of 25 Watt). The imaged precursor was gently cleaned with water, removing the black material still left on the imaged background. The lithographic printing plates were then mounted on a Ryobi 520HX press and 140,000 impressions were made showing good image quality. Wear of more than 20% reduction in printed dots size of fine features was seen only after about 130,000 impressions (for 2% dots at 200 lpi screen) and after more than >140,000 impressions (for 5% dots at 200 lpi screen).

A white printed background was obtained, corresponding to a fully imaged area on the lithographic printing plate. This was observed from the beginning of the printing test.

On the other hand, when the imaged precursor was mounted onto a printing press without first water cleaning it, the white printed background was obtained only after about 50 impressions, that is, the black material left on the imaged background was removed on press and so in this case the imaged precursor was developed on-press.

However, when the precursor was imaged using a more powerful laser of a Kodak® Thermo Flex 400 imager (having 48 diodes of 1 Watt each), the imaged areas on the imaged precursor were almost completely clean after imaging (only trace amounts of debris were left in the imaged background). In this case, the imaged precursor was not cleaned after imaging and the trace amounts of debris were easily removed by the fountain solution on-press during printing. Indeed, the fully imaged areas that were not clean, printed white background and this was observed from the beginning of the printing test. Therefore, it is possible to achieve literally processless plates by ablation imaging.

Compared with the lithographic printing plate precursor of Invention Example 1, the results described in Invention Example 5 show that adding phosphoric acid to the crosslinked hydrophilic inner layer led to a much improved print run length for the lithographic printing plate. It is believed that the added phosphoric acid may improve the adhesion between the crosslinked hydrophilic inner layer and the oleophilic outer layer, leading to improved print run length for the resulting lithographic printing plate.

When a lithographic printing plate precursors was similarly prepared, but the drying step for the oleophilic outer layer was combined with the described heating step, so that the drying and heating was carried out simultaneously for 75 seconds at 240° C., a lithographic printing plate with similar properties was obtained, which exhibited similar print run length to that obtained using separating drying and heating steps. Therefore, if needed, the drying and heating steps can be applied simultaneously with high enough temperature.

### Invention Example 6

Lithographic printing plate precursors of this invention were prepared using the same general procedure described above for Invention Example 5, except that an increased amount of phosphoric acid was added to the crosslinked hydrophilic inner layer. The hydrophilic inner layer formulation was prepared using the following components.

| Hydrophilic Inner Layer | Weight | Dry Weight |
|---|---|---|
| Formulation | (g) | (%) |
| Celvol ® 125* | 77.185 | 91.61 |
| Glyoxal solution** | 0.454 | 5.39 |
| Phosphoric acid solution*** | 0.119 | 3.0 |
| Water | 2.242 | 0 |

*4 weight % of PVA in water
**40 weight % of Glyoxal in water
***85 weight % of phosphoric acid in water

As described above for Invention Example 5, the formulation was applied to an electrochemically roughened and phosphoric anodized aluminum substrate that was subjected to an after treatment using an aqueous solution of poly acrylic acid by means of common methods and the coating dried for 1 minute at 120° C. in an oven. The weight of the hydrophilic layer was approx. 1.7 g/m². The oleophilic outer layer formulation was applied as described in Invention Example 1.

The lithographic printing plate precursors were exposed at 1500 mJ/cm² with a Kodak® Lotem 400 Quantum imager (having 1 bar of diodes, 224 valves and overall intensity of 25 Watt). The imaged precursor was gently cleaned with water, thereby removing the black material still left on the imaged background. The imaged precursors were then mounted on a Ryobi 520HX printing press and 210,000 impressions were made showing good image quality. Wear of more than 20% reduction in printed dots size of fine features was seen only after about 200,000 impressions (for 2% dots at 200 lpi screen) and after more than 210,000 impressions (for 5% dots at 200 lpi screen). A white printed background was obtained, corresponding to a fully imaged area on the lithographic printing plate. This was observed from the beginning of the printing test.

On the other hand, when the imaged precursor was mounted onto a printing press without first water cleaning, the white printed background was obtained only after about 50 impressions. That is, the black material left on the imaged background was removed on-press during printing and in this case the imaged precursor was developed on-press.

However, when the lithographic printing plate precursor was imaged with a more powerful laser of a Kodak® Thermo Flex 400 imager (having 48 diodes of 1 Watt each) then the imaged areas on the imaged precursor were almost completely clean after imaging (only trace amounts of debris left in the imaged background). In this case, the imaged precursor was not cleaned after imaging and the trace amounts of debris left after imaging were easily removed by the fountain solution during printing on-press. Fully imaged areas that were not cleaned printed white background, and this was observed from the beginning of the printing test. Therefore, in this case it was possible to achieve literally processless plates by ablation imaging.

Compared with the lithographic printing plate precursor described in Invention Example 5, the results described in this Invention Example 6 show that further increasing the phosphoric acid weight % (from 1.5 weight % to 3 weight %) in the crosslinked hydrophilic inner layer led to a much improved print run length in the resulting lithographic printing plate.

### Invention Example 7

Lithographic printing plate precursors of this invention were prepared using the same general procedure described above for Invention Example 6, except that an increased amount of phosphoric acid was added to the crosslinked hydrophilic inner layer. The hydrophilic inner layer was prepared using the following components:

| Hydrophilic Inner Layer | Weight | Dry Weight |
|---|---|---|
| Formulation | (g) | (%) |
| Celvol ® 125* | 57.275 | 90.67 |
| Glyoxal solution** | 0.337 | 5.33 |
| Phosphoric acid solution*** | 0.119 | 4.0 |
| Water | 2.269 | 0 |

*4 weight % of PVA in water
**40 weight % of Glyoxal in water
***85 weight % of phosphoric acid in water

As described above for Invention Example 6, the hydrophilic inner layer formulation was applied to an electrochemically roughened and phosphoric anodized aluminum substrate that was subjected to an after treatment using an aqueous solution of poly(acrylic acid) using known methods and the coating was dried for 1 minute at 120° C. in an oven. The weight of the crosslinked hydrophilic inner layer was approx. 1.7 g/m². The oleophilic outer layer was prepared and applied as described in Invention Example 6.

The lithographic printing plate precursors were exposed at 1500 mJ/cm² using a Kodak® Lotem 400 Quantum imager (having 1 bar of diodes, 224 valves and overall intensity of 25 Watt) and also with the more powerful laser of a Kodak® Thermo Flex 400 imager (having 48 diodes of 1 Watt each). The imaged precursors were cleaned with water, removing most of the black material still left on the imaged background. However, it was not possible to fully clean the imaged background. The use of 4 weight % of the phosphoric acid may have reduced precursor sensitivity, but this is only a theory at this point.

### Invention Example 8

Lithographic printing plate precursors of this invention were prepared using the same general procedure described above for Invention Example 6, except that the electrochemically roughened and phosphoric anodized aluminum substrate had not been subjected to a post treatment.

The precursors were exposed at 1500 mJ/cm² with a Kodak® Lotem 400 Quantum imager (having 1 bar of diodes, 224 valves and overall intensity of 25 Watt). The imaged precursor was gently cleaned with water, removing the black material still left on the imaged background. The lithographic printing plates were then mounted on a Ryobi 520HX printing press and 180,000 impressions were made showing good image quality. Wear of more than 20% reduction in printed dots size of fine features was seen only after about 90,000 impressions (for 2% dots at 200 lpi screen) and after about 110,000 impressions (for 5% dots at 200 lpi screen). A white printed background was obtained, corresponding to a fully imaged area on the printing plate. This was observed from the beginning of the printing test.

On the other hand, when the imaged precursor was mounted onto a printing press without water cleaning it, the white printed background was obtained only after about 50 impressions. That is, the black material left on the imaged background was removed on-press and the imaged precursor was developed on-press.

However, when the lithographic printing plate precursor was imaged using a more powerful laser of a Kodak® Thermo Flex 400 imager (having 48 diodes of 1 Watt each), the imaged areas on the imaged precursor were almost completely clean after imaging (only trace amounts of debris left in the imaged background). The imaged precursor was not cleaned after imaging and the trace amounts of debris left on the printing plate after imaging were easily removed by the fountain solution on-press. Fully imaged areas that were not cleaned, printed white background and this was observed from the beginning of the printing test. In this case, it was possible to achieve literally processless plates by ablation imaging.

Compared with the lithographic printing plate precursor described for Invention Example 2, the results described for Invention Example 8 show that adding phosphoric acid to the crosslinked hydrophilic inner layer led to an improved print run length. It is believed that the added phosphoric acid in the crosslinked hydrophilic inner layer improved the adhesion between the crosslinked hydrophilic inner layer and the oleophilic outer layer, leading to improved print run length.

### Invention Example 9

Lithographic printing plate precursors of this invention were prepared using the same general procedure described above for Invention Example 8, except that an increased amount of phosphoric acid was added to the crosslinked hydrophilic inner layer. In this example, 4 weight % of phosphoric acid was used in the crosslinked hydrophilic inner layer as described for Invention Example 7. The oleophilic outer layer was prepared as described above for Invention Example 8.

The lithographic printing plate precursors were exposed at 1500 mJ/cm² using a Kodak® Lotem 400 Quantum imager (having 1 bar of diodes, 224 valves and overall intensity of 25 Watt). The imaged precursor was gently cleaned with water, removing the black material still left on the imaged background. The imaged precursors described for Invention Examples 6 and 9 were then mounted together on a Ryobi 520HX printing press so that their print run length could be compared in the same printing test. Both lithographic printing plates showed good image quality and similar print run length.

As with the precursor described for Invention Example 6, when the precursor of Invention Example 9 was imaged with a more powerful laser of a Kodak® Thermo Flex 400 imager (having 48 diodes of 1 Watt each), the imaged areas on the precursor were almost completely clean after imaging (only trace amounts of debris left in the imaged background). In this case, the imaged precursor was not cleaned after imaging and the trace amounts of debris left on the printing plate after imaging were easily removed by the fountain solution during printing on-press. Fully imaged areas that were not cleaned printed white background, and this was observed from the beginning of the printing test. It is possible to achieve literally processless plates by ablation imaging.

Compared with the lithographic printing plate precursor described for Invention Example 8, the results described for this Invention Example 9 show that further increasing the phosphoric acid (from 3 weight % to 4 weight %) in the crosslinked hydrophilic inner layer led to a much improved print run length.

Furthermore, the use of 4 weight % of phosphoric acid in the crosslinked hydrophilic inner layer of Invention Example 9 allowed to use of an electrochemically roughened and phosphoric anodized aluminum substrate that had not been subjected to a post treatment with an aqueous solution of poly(acrylic acid) and provided similar print run length as that obtained with an analogous lithographic printing plate (obtained in Invention Example 6) that had substrate that had been subjected to a post treatment with an aqueous solution of poly(acrylic acid) but which contained a lesser amount of phosphoric acid (3 weight % vs. 4 weight % of Invention Example 9).

### Invention Example 10

Lithographic printing plate precursors were prepared using the same general procedure described above for Invention Example 9, except that an increased amount of phosphoric acid was added to the crosslinked hydrophilic inner layer. The hydrophilic inner layer formulation used to provide the crosslinked hydrophilic inner layer contained the following components.

| Hydrophilic Inner Layer | Weight | Dry Weight |
|---|---|---|
| Formulation | (g) | (%) |
| Celvol ® 125* | 37.783 | 89.72 |
| Glyoxal solution** | 0.222 | 5.28 |
| Phosphoric acid solution*** | 0.099 | 5.0 |
| Water | 1.896 | 0 |

*4 weight % of PVA in water
**40 weight % of Glyoxal in water
***85 weight % of phosphoric acid in water

As described in Invention Example 9, the hydrophilic inner layer formulation was applied to an electrochemically roughened and phosphoric anodized aluminum substrate that had not been post treated and the coating was dried for 1 minute at 120° C. in an oven to provide a dry coverage of about 1.7 g/m². The oleophilic outer layer formulation was applied over the crosslinked hydrophilic inner layer.

The precursors were exposed at 1500 mJ/cm² using a Kodak® Lotem 400 Quantum imager (having 1 bar of diodes, 224 valves and overall intensity of 25 Watt) and also with the more powerful laser of a Kodak® Thermo Flex 400 imager (having 48 diodes of 1 Watt each). The imaged precursors were cleaned with water, removing most of the black material still left on the imaged background. However, in contrast to the above invention examples (except Invention Example 7), in this case it was not possible to fully clean the imaged background. The use of 5 weight % of the phosphoric acid may have reduced the precursor sensitivity.

Among the various precursors tested and described herein, the lithographic printing plate precursors of Invention Examples 6 and 9 showed the best print run length that was found to be similar for both precursors. Therefore, the lithographic printing plates obtained from these examples served as “standard” plates in the printing tests described below. The print run lengths described in the Invention Examples below are reported in relation (%) to the print run length obtained with the “standard” lithographic printing plates of Invention Examples 6 and 9.

### Invention Example 11

Lithographic printing plate precursors were prepared using the same general procedure described above for Invention Example 9, except using an electrochemically roughened and sulfuric anodized aluminum substrate that had columnar pores in the anodized layer that had been widened with an alkaline solution as described in copending and commonly assigned U.S. Ser. No. 13/221,936, (noted above, filed by Hayashi) that is incorporated herein by reference. The oleophilic outer layer formulation was applied as described in Invention Example 9.

The precursors were exposed at 1500 mJ/cm² using a Kodak® Lotem 400 Quantum imager (having 1 bar of diodes, 224 valves and overall intensity of 25 Watt). The imaged precursor was gently cleaned with water, removing the black material still left on the imaged background. The imaged precursors of Invention Examples 9 and 11 were then mounted together on a Ryobi 520HX printing press so that their print run length could be compared in the same printing test. Both lithographic printing plates showed good image quality and the lithographic printing plate of Invention Example 11 showed a print run length of ˜85% of that obtained with the standard lithographic printing plate of Invention Example 9.

As with the lithographic printing plate of Invention Example 9, when the lithographic printing plate of invention Example 11 was imaged with a more powerful laser of a Kodak® Thermo Flex 400 imager (having 48 diodes of 1 Watt each), the imaged areas on the imaged precursor were almost completely clean after imaging (only trace amounts of debris left in the imaged background). In this case, the imaged precursor was not cleaned after imaging and the trace amounts of debris left were easily removed by the fountain solution during on-press printing. Fully imaged areas that were not cleaned printed white background, and this was observed from the beginning of the printing test. In this case, it was possible to achieve literally processless plates by ablation imaging.

The print run length obtained with the lithographic printing plate of Invention Example 11 was acceptable compared to that obtained with the lithographic printing plate of Invention Example 9 and it was much improved compared to the print run length obtained with the lithographic printing plate of Comparative Example 1 (see below).

### Invention Example 12

Lithographic printing plate precursors of this invention were prepared using the same general procedure described above for Invention Example 9, except that after the drying of the oleophilic outer layer formulation for 1 minute at 100° C., the precursor was further heated using a shortwave IR lamp for 2 seconds. The precursor was moved by a conveyor under the shortwave IR lamp at such a speed that each portion of the precursor moved under (the width of) the switched on shortwave IR lamp for a duration of 2 seconds (precursor exposure duration to IR radiation). The shortwave IR lamp that was used can generate up to 75 W/cm but it was operated such that it would irradiate at 70% of its maximum power and it was placed 9.5 cm above the precursor. This shortwave IR lamp was obtained from Heraeus Noblelight-Germany.

The precursors were exposed at 1500 mJ/cm² using a Kodak® Lotem 400 Quantum imager (having 1 bar of diodes, 224 valves and overall intensity of 25 Watt). The imaged precursor was gently cleaned with water, removing the black material still left on the imaged background. The imaged precursors of Invention Examples 9 and 12 were then mounted together on a Ryobi 520HX printing press so that their print run length could be compared in the same printing test. Both lithographic printing plates showed good image quality and the lithographic printing plate of Invention Example 12 showed a print run length of ˜96% of that obtained using the standard lithographic printing plate of Invention Example 9. As with the precursor of Invention Example 9, when the precursor of Invention Example 12 was imaged with a more powerful laser of a Kodak® Thermo Flex 400 imager (having 48 diodes of 1 Watt each), the imaged areas on the imaged precursor were almost completely clean after imaging (only trace amounts of debris left in the imaged background). In this case, the imaged precursor was not cleaned after imaging and the trace amounts of debris left on the printing plate after imaging were easily removed by the fountain solution during printing on-press. Fully imaged areas that were not cleaned printed white background, and this was observed from the beginning of the printing test. In this case, it was possible to achieve literally processless plates by ablation imaging.

The good print run length obtained with the lithographic printing plate of Invention Example 12 demonstrates that the heating duration can be significantly reduced when a short wave IR lamp is used.

### Invention Examples 13-19

To evaluate the effect of heating the lithographic printing plate precursors (after the oleophilic outer layer formulation was first dried for 1 minute at 100° C. and before laser imaging) on the coating adhesion and print run lengths, precursors were prepared according to this invention using the same general procedure described above for Invention Examples 6 and 9, except this time the precursors were further heated at different temperatures and durations (see Invention Examples 13-19 in TABLE I below) compared to the conditions used in Invention Examples 6 and 9 (75 seconds at 240° C.). After the drying step of 1 minute at 100° C. the precursors of Invention Examples 13-19 were heated at various temperatures in a Wisconsin oven.

The precursors of Invention Examples 13-19 were exposed at 1500 mJ/cm² using a Kodak® Lotem 400 Quantum imager (having 1 bar of diodes, 224 valves and overall intensity of 25 Watt). The imaged precursors were gently cleaned with water, removing the black material still left on the imaged background. In several printing tests, the imaged precursors of Invention Examples 13-19 were then mounted on a Ryobi 520HX printing press together with the standard imaged precursor of Invention Examples 6 or 9, respectively, so that their relative print run lengths could be compared to the standard imaged lithographic printing plate. The relative (%) printing run length of Invention Examples 13-19 are shown below in TABLE I and were compared relative to the print run lengths of the standard printing plates of Invention Examples 6 and 9, which showed similar and best print run lengths among the lithographic printing plates tested, and for which a relative print run length of 100% was assigned. A white printed background was obtained with all the lithographic printing plates of Invention Examples 6, 9, and 13-19, corresponding to a fully imaged area on the lithographic printing plate. This was observed from the beginning of the printing test.

On the other hand, when the imaged precursor was mounted on the printing press without first water cleaning, the white printed background was obtained only after about 50 impressions. That is, the black material left on the imaged background was removed during printing on-press and so in this case the imaged precursor was developed on-press.

However, when the precursors of Invention Examples 6, 9, and 13-19 were imaged with a more powerful laser of a Kodak® Thermo Flex 400 imager (having 48 diodes of 1 Watt each), the imaged areas on the imaged precursors were almost completely clean after imaging (only trace amounts of debris left in the imaged background). In this case, the imaged precursor was not cleaned after imaging and the trace amounts of debris left on the imaged precursors after imaging were easily removed by the fountain solution during printing on-press. Fully imaged areas that were not cleaned printed white background, and this was observed from the beginning of the printing test. In these cases, it was possible to achieve literally processless plates by ablation imaging.

The relative print run lengths obtained with the lithographic printing plates of Invention Examples 6, 9, 11, and 13-19 (see TABLE I) imply that heating the lithographic printing plate precursors with a Wisconsin oven at a higher temperature and for a longer duration than the drying of the oleophilic outer layer formulation leads to improved print run length.

The best heating temperature and duration can then be chosen such that the best print run length is obtained while still maintaining white printed background (no printed toning). The good print run length obtained with the printing plate of Invention Example 12 demonstrates that the heating duration can significantly be reduced when a short wave IR lamp is used to heat the plate. This can be particularly useful if the heating of the precursors is carried out in-line during precursor manufactured. The precursors can alternatively be heated off the manufacturing line after the last applied layer is dried at a lower temperature. In this case, and if needed, the heating duration can be different than that used in-line (where the manufacturing line speed is set to accommodate other needs such as high operating speed for improved efficiency).

### Rubbing Tests:

A rubbing test was developed to clearly distinguish suitable pre-heating conditions from unsuitable pre-heating conditions by using a Crockmeter as a means of rubbing test (see ASTM D3181) using a PM/MEK solvent mixture (65:35 weight ratio) on a rubbing cloth. Adhesion of the oleophilic outer layer to the crosslinked hydrophilic inner layer was evaluated. The lithographic printing plate precursors were rubbed for up to 1000 times and those showing less than 10% optical density change as measured with a spectrodensitometer (see TABLE I below) within a first rectangular area defined by width W1 and length L1 centered inside a second rectangular area defined by width W2 and length L2, wherein W1 is 0.7 times W2, L1 is 0.7 times L2, W2 is 1.5 cm, and L2 is 12 cm, are considered suitable. As can be seen from the results in TABLE I, the precursors of Invention Examples 6, 9, 11, 12, 18, and 19 show the lower optical density change (among the imageable elements tested) when rubbed for 1000 times as described above and hence show the best layer adhesion. It can also be seen from the data in TABLE I that the lithographic printing plates obtained from Invention Examples 6, 9, 11, 12, 18, and 19 exhibited good print run lengths. The results summarized in TABLE I indicate that there is a general quantitative trend of good rubbing resistance, indicating good print run length.

TABLE I

| | Highest optical density | |
|---|---|---|
| | change (%) measured on | |
| | the lithographic printing | |
| | plate precursors within a | |
| | first rectangular area | Relative print |
| | defined by width W1 and | run length (%) |
| | length L1 centered inside | obtained with |
| Lithographic printing plate | a second rectangular area | the lithographic |
| precursors that were prepared by | defined by width W2 and | printing plates; |
| using the same general procedure | length L2, wherein W1 is | the values shown |
| described above for Invention | 0.7 times W2, L1 is 0.7 | are averaged |
| Example 6 or 9 but were further | times L2, W2 is 1.5 cm, | over the wear |
| heated (after the last drying step of | and L2 is 12 cm, after | measured for the |
| 1 minute at 100° C.) at the conditions | certain number of rubs | printed 2 and 5 |
| indicated below* | (as described above). | dot % |
| Comparative Example 4: Analogous | 56% already after 36 rubs | <1 |
| precursor to that of Invention Example | | |
| 6 but it was not further heated (after | | |
| the drying step of 1 minute at 100° C.) | | |
| Comparative Example 5: Analogous | 55% already after 25 rubs | <1 |
| precursor to that of Invention Example | | |
| 9 but it was not further heated (after | | |
| the drying step of 1 minute at 100° C.) | | |
| Invention Example 13: Analogous | 57% already after 200 rubs | 28 |
| precursor to that of Invention Example | | |
| 6 but it was further heated (after the | | |
| drying step of 1 minute at 100° C.) at | | |
| 200° C. for 75 seconds | | |
| Invention Example 14: Analogous | 48% already after 900 rubs | 29 |
| precursor to that of Invention Example | | |
| 6 but it was further heated (after the | | |
| drying step of 1 minute at 100° C.) at | | |
| 240° C. for 30 seconds | | |
| Invention Example 15: Analogous | 35% after 1000 rubs | 50 |
| precursor to that of Invention Example | | |
| 6 but it was further heated (after the | | |
| drying step of 1 minute at 100° C.) at | | |
| 280° C. for 25 seconds | | |
| Invention Example 16: Analogous | 25% after 1000 rubs | 52 |
| precursor to that of Invention Example | | |
| 6 but it was further heated (after the | | |
| drying step of 1 minute at 100° C.) at | | |
| 260° C. for 30 seconds | | |
| Invention Example 17: Analogous | 51% after 600 rubs | 76 |
| precursor to that of Invention Example | | |
| 6 but it was further heated (after the | | |
| drying step of 1 minute at 100° C.) at | | |
| 220° C. for 75 seconds | | |
| Invention Example 18: Analogous | Less than 10% after 1000 | 80 |
| precursor to that of Invention Example | rubs | |
| 6 but it was further heated (after the | | |
| drying step of 1 minute at 100° C.) at | | |
| 300° C. for 25 seconds | | |
| Invention Example 19: Analogous | Less than 10% after 1000 | 87 |
| precursor to that of Invention Example | rubs | |
| 6 but it was further heated (after the | | |
| drying step of 1 minute at 100° C.) at | | |
| 280° C. for 30 seconds | | |
| Invention Example 6: The precursor | Less than 10% after 1000 | 100 |
| was further heated (after the drying | rubs | |
| step of 1 minute at 100° C.) at 240° C. | | |
| for 75 seconds | | |
| Invention Example 9: The precursor | Less than 10% after 1000 | 100 |
| was further heated (after the drying | rubs | |
| step of 1 minute at 100° C.) at 240° C. | | |
| for 75 seconds | | |
| Invention Example 11: Analogous | Less than 10% after 1000 | 85 |
| precursor to that of Invention Example | rubs | |
| 9 that was further heated (after the | | |
| drying step of 1 minute at 100° C.) at | | |
| 240° C. for 75 seconds but the | | |
| precursor contained a sulfuric | | |
| anodized aluminum substrate having | | |
| its columnar pores widened | | |
| Invention Example 12: Analogous | Less than 10% after | 96 |
| precursor to that of Invention Example | 1000 rubs | |
| 9 but it was further heated (after the | | |
| drying step of 1 minute at 100° C.) for | | |
| only 2 seconds with a shortwave IR | | |
| lamp operated to irradiate only 70% of | | |
| its maximum power (75 W/cm) while | | |
| placed 9.5 cm above the precursor | | |

*All precursors except that of Invention Example 12 were heated using a Wisconsin oven.

All the lithographic printing plates of Invention Examples 6, 9, and 11-19 provided good image quality. As with the lithographic printing plate precursors of Invention Example 6 and 9, when the lithographic printing plate precursors of Invention Examples 11-19 were imaged using a more powerful laser of a Kodak® Thermo Flex 400 imager (having 48 diodes of 1 Watt each), the imaged areas on the imaged precursors were almost completely clean after imaging (only trace amounts of debris left in the imaged background). In these cases, the plates were not cleaned after imaging and the trace amounts of debris left on the imaged precursors were easily removed by the fountain solution during printing on-press. Fully imaged areas that were not cleaned printed white background, and this was observed from the beginning of the print test. Therefore, in these cases it is possible to achieve literally processless plates by ablation imaging.

### Soak Tests:

As can be seen in TABLE I, the lithographic printing plate precursors of Comparative Examples 4 and 5 showed poor coating adhesion (rub tests) and the corresponding lithographic printing plates showed poor print run lengths. However, even though the precursors of Comparative Examples 4 and 5 were not further heated after the oleophilic outer layer drying step of 1 minute at only 100° C., soaking these precursors for 20 minutes in a PM:MEK mixture (65:35 weight ratio) showed no meaningful dissolution of the oleophilic outer layer. The PM/MEK solvent mixture remained clear and colorless after the tests were completed and the color of the oleophilic upper layer of the soaked precursors remained black and similar to the part of the precursor that was not soaked in the noted solvent mixture. The optical densities that were measured (using a Spectropens densitometer obtained from Techkon—Germany) both before soaking and after soaking for 20 minutes in the noted PM/MEK solvent mixture were 2.23 and 2.13, respectively, for Comparative Examples 4 and 2.23 and 2.07, respectively, for Comparative Examples 5. Thus, even without further heating the precursors and after drying the oleophilic outer layer formulation at 100° C. for 1 minute, the oleophilic outer layer was already resistant to the noted solvent mixture, and their measured optical densities (after soaking) are just slightly less than when the precursor was also heated at 240° C. for 75 seconds. For comparison, optical densities of 2.20 were measured both before and after soaking the precursors of Invention Example 9 that was further heated at 240° C. for 75 seconds after the oleophilic outer layer drying step of 1 minute at 100° C.

While the noted PM/MEK solvent mixture did not solubilize the oleophilic outer layer of the precursors of Comparative Examples 4, 5, and 9, it loosened the adhesion between the oleophilic outer layer and the crosslinked hydrophilic inner layer in precursors of Comparative Examples 4 and 5 that were not further heated after the drying step for 1 minute at 100° C. (see rubbing tests in TABLE I).

While not being limited to a particular mechanism, the solvent resistance of the oleophilic outer layer in the precursors described above is believed to be caused by π-π stacking of the planar phthalimide units on the MN-24 polymer used in the oleophilic outer layer, as opposed to migration of the dialdehyde from the crosslinked hydrophilic inner layer. Coating the oleophilic outer layer for Invention Example 9 directly onto a sulfuric acid anodized aluminum substrate that was also used in Comparative Example 1 (but without the crosslinked hydrophilic inner layer) and drying for 1 minute at 100° C. (without further heating) also led to a precursor that has a solvent resistant oleophilic outer layer formulation as above. In this case, optical densities of 2.23 and 2.18 were measured before and after soaking at the same soaking conditions described above, respectively.

### Comparative Example 1

Lithographic printing plate precursors were prepared outside the scope of the present invention using the same general procedure described above for Invention Example 1, but using an electrochemically roughened and sulfuric acid anodized aluminum substrate that was subjected to a post treatment using an aqueous solution of sodium phosphate/sodium fluoride by means of known methods.

The lithographic printing plate precursors were exposed at 1500 mJ/cm² with a Kodak® Lotem 400 Quantum imager (having 1 bar of diodes, 224 valves and overall intensity of 25 Watt). The imaged precursors were gently wet cleaned with water, removing the black material still left on the imaged background. The imaged precursors were then mounted on a Ryobi 520HX press and 100,000 impressions were made showing good image quality. Wear of more than 20% reduction in printed dots size of fine features (5% dots at 200 lpi screen) was seen only after about 25,000 impressions. A white printed background was obtained, corresponding to a fully imaged area on the lithographic printing plates as observed from the beginning of the print test.

On the other hand, when the imaged precursors were mounted on the printing press without first water cleaning, the white printed background was obtained only after about 50 impressions. That is, the black material left on the imaged background was removed on the printing press and in these embodiments the imaged precursors were developed on the printing press.

However, when the precursors were imaged with a more powerful laser of a Kodak® Thermo Flex 400 imager (having 48 diodes of 1 Watt each), the imaged areas on the imaged precursors were almost completely clean after imaging (only trace amounts of debris left in the imaged background). In these embodiments, the imaged precursors were not cleaned after imaging and the trace amounts of debris left on the printing plate after imaging were easily removed by the fountain solution on the printing press during printing. Fully imaged areas that were not cleaned, printed white background as observed from the beginning of the print test. Therefore, it was possible to achieve processless lithographic printing plates using ablation imaging.

### Comparative Example 2

Lithographic printing plate precursors were prepared using the same general procedure as described above for Invention Example 3, but an electrochemically roughened and sulfuric acid anodized aluminum substrate was used, which substrate has been subjected to a post treatment using an aqueous solution of sodium phosphate/sodium fluoride and common methods.

The lithographic printing plate precursors were exposed at 1500 mJ/cm² using a Kodak® Lotem 400 Quantum imager (having 1 bar of diodes, 224 valves and overall intensity of 25 Watt). The resulting lithographic printing plates were gently wet cleaned with water, removing the black material still left on the imaged background. The cleaned lithographic printing plates were then mounted on a Ryobi 520HX press and 100,000 impressions were made that exhibited good image quality. However, wear of more than 20% reduction in printed dots size of fine features (5% dots at 200 lpi screen) was seen only after about 20,000 impressions. A white printed background was obtained, corresponding to a fully imaged area on the lithographic printing plate that was observed from the beginning of the printing test.

On the other hand, when the imaged printing plate was mounted on the printing press without first water cleaning it, the white printed background was obtained only after about 50 impressions. That is, the black material left on the imaged background was removed on the printing press and in this case, the imaged precursor was developed on press.

However, when the lithographic printing plate precursors were imaged with a more powerful laser on a Kodak® Thermo Flex 400 imager (having 48 diodes of 1 Watt each), the imaged areas on the resulting lithographic printing plates were almost completely clean after imaging (only trace amounts of debris left in the imaged background). Thus, the lithographic printing plates were not cleaned after imaging and the trace amounts of debris left on the printing plate after imaging were easily removed by the fountain solution on press. Indeed, fully imaged areas that were not cleaned, printed white background, as observed from the beginning of the printing test. Therefore, in this case, it is possible to achieve literally processless plates by ablation.

### Comparative Example 3

Lithographic printing plate precursors were prepared using the same general procedure described above for Invention Example 4, but an electrochemically roughened and sulfuric acid anodized aluminum substrate was used, which substrate had been subjected to a post treatment using an aqueous solution of sodium phosphate/sodium fluoride and common methods.

The precursors were exposed at 1500 mJ/cm² with a Kodak® Lotem 400 Quantum imager (having 1 bar of diodes, 224 valves and overall intensity of 25 Watt). The resulting lithographic printing plates were gently wet cleaned with water, removing the black material still left on the imaged background. The lithographic printing plates were then mounted on a Ryobi 520HX press and 100,000 impressions were made showing good image quality. However, wear of more than 20% reduction in printed dots size of fine features (5% dots at 200 lpi screen) was seen only after about 5,000 impressions. A white printed background was obtained, corresponding to a fully imaged area on the lithographic printing plates as observed from the beginning of the printing test.

On the other hand, when the imaged printing plate was mounted on press without first water cleaning it, the white printed background was obtained only after about 50 impressions i.e., the black material left on the imaged background was removed on press and so in this case the plate developed on press.

However, when the lithographic printing plates were imaged with a more powerful laser on a Kodak® Thermo Flex 400 imager (having 48 diodes of 1 Watt each), the imaged areas on the lithographic printing plates were almost completely clean after imaging (only trace amounts of debris left in the imaged background). In these instances, the lithographic printing plates were not cleaned after imaging and the trace amounts of debris left on the printing plate after imaging were easily removed by the fountain solution on press. Indeed, fully imaged areas that were not cleaned, printed white background, as observed from the beginning of the printing test. In this case, it is possible to achieve literally processless plates by ablation.

### Solvent Resistance of the Positive-Working Lithographic Printing Plate Precursors:

Polymer MN-24 can be dissolved in PM or in a PM:MEK (65:35 weight %) mixture that is used in surface layer formulations. However, coatings obtained using these polymers are not soluble with PM or in the noted PM-MEK mixture.

The resistance to press chemicals of the lithographic printing plate precursors prepared in Invention Examples 1, 2, 5, 6, 8, 9, and 11 were evaluated using the following tests:

Solvent Resistance Tests:

Four solvent mixtures were used for these tests:

(1) Butyl Cellosolve (“BC”, 2-butoxyethanol) test, 80% in water

(2) UV Wash test (“Glycol Ether” blends)

(3) Diacetone Alcohol test (“DAA”, 80% in water)

(4) Heatset Fountain Solution E9069/3 test at two different concentrations, 100% and 8% in water. Heatset Fountain Solution E9069/3 is commercial product that comprises 2-(2-butoxyethoxy)ethanol, Bronopol, ethanediol, and propan-2,1-diol.

For each test, drops of the each solvent mixture was placed on a 35% screen (200 lpi) region of the imaged lithographic printing plate precursors that were wet cleaned with water, and then the drops were removed with a cloth. Each test was carried out at about 23° C. A measurement of less than 5% reduction in the dot size (in regions on the 35% screen where drops of the solvents were present, compared to areas that had no solvent contact) is considered acceptable. The dot size before and 20 minutes after the solvent contact was measured using a spectroplate. After the solvent drops were on the precursors for 20 minutes, each imaged precursors was then mounted onto a Ryobi 520HX printing press and 5000 impressions were made to see if the dots remained on the lithographic printing plates. A spectrodense was used to measure the dot area on the printed impressions that corresponded to the regions on the lithographic printing plate precursors that had contact with the solvent mixtures and also those regions that had no contact with the solvents. As noted above, a measurement of less than 5% reduction in the dot size (in regions on the printed impressions corresponding to the 35% screen) is considered acceptable.

Excellent solvent resistance was found for the lithographic printing plate precursors prepared in Invention Examples 1, 2, 5, 6, 8, 9, and 11 for all solvent mixtures used in the evaluations. These results show that the oleophilic surface layer formulations containing the poly(vinyl acetal) having the carboxy-substituted phthalimide acetal recurring units n shown in Scheme 1 above, as primary binder within the scope of this invention, provided lithographic printing plates having excellent solvent resistance to a broad range of press chemicals.

The carboxy-substituted phthalimide acetal random recurring units n shown in Scheme 1 were found to be very efficient in making the lithographic printing plates solvent resistant. This is likely due to the strong π-stacking interaction between the phthalimido groups in the poly(vinyl acetal) resins that is further enhanced by the carboxy substituents in the polymers.

The invention has been described in detail with particular reference to certain preferred embodiments thereof, but it will be understood that variations and modifications can be effected within the spirit and scope of the invention.

1. A method for preparing a positive-working lithographic printing plate precursor, the method comprising:
providing an anodized aluminum substrate comprising an anodic oxide surface having an average oxide pore diameter of at least 15 nm and up to and including 80 nm,
over the anodic oxide surface of the anodized aluminum substrate, providing a crosslinked hydrophilic inner layer by applying an inner layer formulation comprising: (1) a hydrophilic polymer that comprises randomly recurring units represented by —CH₂—CH(OH)— in an amount of at least 70 mol % of the total recurring units, (2) a crosslinking agent for the —CH₂—CH(OH)— recurring units that comprises at least two aldehyde groups, and (3) an acidic compound,
over the crosslinked hydrophilic inner layer, providing an oleophilic outer layer by applying an outer layer formulation comprising: (a) an infrared radiation absorber, and (b) at least one oleophilic polymer that comprises at least 10 mol % randomly recurring units represented by —CH₂—CH(OH)—, based on the total recurring units, dissolved or dispersed within an organic solvent solution, and drying to form a composite structure consisting of the crosslinked hydrophilic inner layer and the oleophilic outer layer, and
heating the formed composite structure such that the surface of the composite structure exhibits less than 10% optical density change within a first rectangular area defined by width W1 and length L1 centered inside a second rectangular area defined by width W2 and length L2, where the surface of the composite structure is subjected to 1000 rubs according to ASTM D3181 using the organic solvent solution, wherein W1 is 0.7 times W2, L1 is 0.7 times L2, W2 is 1.5 cm, and L2 is 12 cm.

2. The method of claim 1, wherein the oleophilic polymer is a poly(vinyl acetyl) comprising at least 15 mol % of randomly recurring acetal units, based on the total recurring units.

3. The method of claim 1, comprising providing a phosphoric acid anodized aluminum substrate comprising the average oxide pore diameter of at least 20 nm and up to and including 60 nm.

4. The method of claim 1, comprising providing a phosphoric acid anodized aluminum substrate comprising the average oxide pore diameter of at least 20 nm and up to and including 40 nm.

5. The method of claim 1, wherein the oleophilic polymer comprises randomly recurring acetal units that are represented by Structure (Ia): 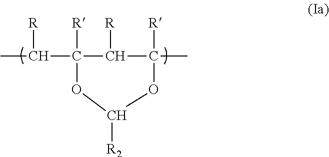
wherein R and R′ are independently hydrogen or a substituted or unsubstituted alkyl group, a substituted or unsubstituted cycloalkyl group, or a halo group,
a) R₂ is a phenyl or naphthyl group that has a cyclic aliphatic or aromatic imide group selected from the group consisting of maleimide, phthalimide, tetrachlorophthalimide, hydroxyphthalimide, carboxypthalimide, nitrophthalimide, chlorophthalimide, bromophthalimide, and naphthalimide groups, wherein the phenyl, naphthyl, or cyclic aliphatic or aromatic imide group is optionally further substituted with one or more substituents selected from the group consisting of hydroxyl, alkyl, alkoxy, and halo groups,
b) R₂ is a nitro-substituted phenol, nitro-substituted naphthol, or nitro-substituted anthracenol, or
c) the oleophilic poly(vinyl acetal) comprises a combination of two or more different randomly recurring acetal units represented by Structure (Ia) wherein R₂ represents two or more different groups listed in a) and b).

6. The method of claim 5, wherein the oleophilic polymer is a poly(vinyl acetal) that also comprises randomly recurring units represented by Structure (Ib): 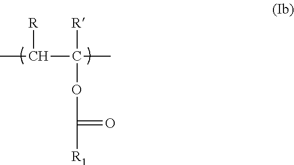
wherein R and R′ are independently hydrogen or a substituted or unsubstituted alkyl group, a substituted or unsubstituted cycloalkyl group, or a halo group, and R₁ is a substituted or unsubstituted linear or branched alkyl group having 1 to 12 carbon atoms, a substituted or unsubstituted cycloalkyl having 5 to 10 carbon atoms in the carbocyclic ring, or a substituted or unsubstituted aryl group having 6 or 10 carbon atoms in the aromatic ring.

7. The method of claim 1, wherein the oleophilic polymer further comprises randomly recurring units represented by one or both of the following Structures (Ic) and (Id): 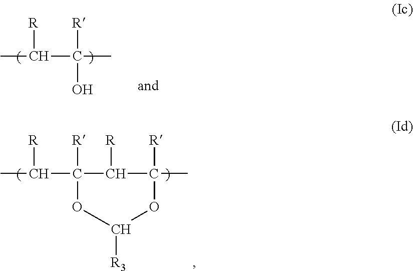
wherein R and R′ are independently hydrogen or a substituted or unsubstituted alkyl group, a substituted or unsubstituted cycloalkyl group, or a halo group,
R₃ is hydrogen or a substituted or unsubstituted alkyl group, a substituted or unsubstituted cycloalkyl group, or an aryl group that is unsubstituted or substituted with at least one hydroxy group.

8. The method of claim 1, wherein the hydrophilic polymer is a poly(vinyl alcohol) that is present in the inner layer formulation in an amount of at least 50% solids.

9. The method of claim 1, wherein the crosslinking agent is ethane-1,2-tiol that is present in the inner layer formulation in an amount of at least 2% based on total formulation solids.

10. The method of claim 1, wherein the acidic compound is phosphoric acid that is present in the inner layer formulation in an amount of at least 1% based on the total formulation solids.

11. The method of claim 1, wherein prior to applying the inner layer formulation, treating the anodic oxide surface layer with a hydrophilic polymer having at least 70 mol % randomly recurring units derived from acrylic acid, methacrylic acid, or both.

12. The method of claim 1, wherein the oleophilic polymer is present in the outer layer formulation in an amount of at least 50% and to and including 95% based on total solids.

13. The method of claim 1, wherein the surface layer formulation comprises an infrared radiation absorber that is a carbon black.

14. The method of claim 1, comprising:
applying the inner layer formulation to provide a dry coverage of at least 0.5 g/m² and up to and including 4 g/m², and
applying the outer layer formulation to provide a dry coverage of at least 0.7 g/m² and up to and including 2.5 g/m².

15. A positive-working lithographic printing plate precursor prepared by the method of claim 1,
wherein the lithographic printing plate comprises:
an anodized aluminum substrate comprising an anodic oxide surface having an average oxide pore diameter of at least 15 nm and up to and including 80 nm,
over the anodic oxide surface of the anodized aluminum substrate, a crosslinked hydrophilic inner layer comprising: (1) a hydrophilic polymer that comprises randomly recurring units represented by —CH₂—CH(OH)— in an amount of at least 70 mol % of the total recurring units, (2) a crosslinking agent for the —CH₂—CH(OH)— recurring units that comprises at least two aldehyde groups, and (3) an acidic compound, and
over the crosslinked hydrophilic inner layer, an oleophilic outer layer comprising: (a) an infrared radiation absorber, and (b) at least one oleophilic polymer that comprises at least 10 mol % randomly recurring units represented by —CH₂—CH(OH)—, based on the total recurring units,
the precursor further comprising a composite structure consisting of the crosslinked hydrophilic inner layer and the oleophilic outer layer,
wherein the surface of the composite structure exhibits less than 10% optical density change within a first rectangular area defined by width W1 and length L1 centered inside a second rectangular area defined by width W2 and length L2, where the surface of the composite structure is subjected to 1000 rubs according to ASTM D3181 using an organic solvent solution used to form the oleophilic outer layer, wherein W1 is 0.7 times W2, L1 is 0.7 times L2, W2 is 1.5 cm, and L2 is 12 cm.

16. A method for providing a lithographic printing plate, comprising:
imagewise exposing the positive-working lithographic printing plate precursor of claim 14 to remove the oleophilic outer layer in exposed regions by ablation to prepare a lithographic printing plate ready for printing without further treatment or processing.

17. The method of claim 16, wherein the imagewise exposing is carried out using infrared radiation at an energy of at least 1 J/cm².

18. The method of claim 16, wherein without intermediate contact with a solution after the imagewise exposing, using the lithographic printing plate for lithographic printing.
